(19) United States
(12) Patent Application Publication
(10) Pub. No.: US 2006/0003273 A1
(43) Pub. Date: Jan. 5, 2006

(54) Silver halide color photographic material and image forming method

(75) Inventor: Hiroshi Takada, Sagamihara-shi (JP)

Correspondence Address: LUCAS & MERCANTI, LLP, 475 PARK AVENUE SOUTH, 15TH FLOOR, NEW YORK, NY, 10016, US

(73) Assignee: Konica Minolta Photo Imaging, Inc.

(21) Appl. No.: 11/167,334

(22) Filed: Jun. 27, 2005

(30) Foreign Application Priority Data
Jul. 1, 2004 (JP) JP2004-195390

(51) Int. Cl. G03C 1/46

(52) U.S. Cl. 430/502

(57) ABSTRACT

A silver halide color photographic material is disclosed, comprising on a reflective support yellow, magenta and cyan image forming layers, each containing silver halide grains having a chloride content of not less than 90 mol %, wherein a fog density of A(λ) and a maximum density of B(λ) at a wavelength of λ nm of the photographic material which has been exposed and processed, and a fog density of A′(λ) at a wavelength of λ nm of the photographic material which has been subjected to overall exposure to radiation of 300 mR, then, exposed and processed, satisfy the following equations (I), (II) and (III):
B(450)/[A′(450)−A(450)]≧60 (I)
B(550)/[A′(550)−A(550)]≧160 (II)
B(650)/[A′(650)−A(650)]≧260 (III).

This application claims priority from Japanese Patent Application No. JP2004-195390 filed on Jul. 1, 2004, which is incorporated hereinto by reference.

### FIELD OF THE INVENTION

The present invention relates to a silver halide color photographic material and an image forming method, and in particular to a silver halide color photographic material used for printing, achieved reduced variation of fog density in unexposed areas after long-period storage, and an image forming method by use thereof.

### BACKGROUND OF THE INVENTION

Recently, opportunities of treating images as digital data have rapidly increased along with enhancement of computing capability of computers and progress of network techniques. Image information which has been digitized using a scanner or the like, can be relatively readily compiled on a computer or incorporated with data such as letters or illustrations. Examples of hard copy material to prepare a hard copy based on such digitized image information include sublimation type thermal transfer prints, melt type thermal transfer prints, ink jet prints, electrostatic transfer type prints, thermo-autochrome prints and silver halide photographic material. Of these, silver halide photographic material (hereinafter, also denoted as simply as photographic material), which exhibits more superior characteristics than other print materials, such as high sensitivity, superior tone and superior image lasting quality, has been employed for preparation of high quality hard copies.

Image information which has been digitized using a scanner or the like, can be relatively readily compiled on a computer or incorporated with data such as letters or illustrations, increasing opportunities of treating an image in which an image based on photographing data, such as people, scenes and still-life (hereinafter, also denoted as scenic image) is mixed with a text data (specifically, fine and small black text). Accordingly, image output based on digital data needs to simultaneously satisfy two requirements, being that a scenic image is more naturally reproduced and text image is reproduced without bleeding.

Further, resolution of image input apparatuses, such as digital still cameras and film scanners has been markedly enhanced in the last few years and there have been made studies for enhancing resolution of output apparatuses (digital exposure machine) to perform image output that brings out still higher quality image data. Recently, various digital exposure machines have come into the market and various models of digital image exposure apparatuses are commercially available. Further, a number of new digital image exposure apparatuses have been developed in combination with advancement of exposure light sources and control apparatuses. Of such digital image exposure apparatuses, an apparatus employing a light source exhibiting a sharp wavelength distribution, such as lasers and LED, has been becoming the main trend.

However, although many kinds and types of image apparatuses have been launched on the market along with the spread of various kinds of digital image exposure apparatuses, the kind of installed lasers and LED has not been unified and the exposure wavelength or exposure time differs among the various exposure apparatuses. Consequently, the time for digital exposure, which is greatly different from analog exposure of the conventional negative-through system, ranges from 10⁻⁷ sec. to 10⁻² sec., resulting in difference in exposure second time by factor of 10,000 to 100,000 so that latitude for exposure time has been greatly required. Further, digital exposure devices are, in the nature of such instruments, subject to heat so that resistance to temperature and humidity during exposure is strongly demanded more than for image formation using conventional analog exposure apparatuses. Along with popularization of mini-labs, there are photo-shops providing services in which the time from receiving an order from a customer to finished prints is within 35 min. in a short case. Accordingly, the market strongly requires reducing the processing time and providing beautiful images, specifically in digital process even when reducing the processing time.

To achieve improvements in image quality of silver halide color photographic material, one important factor is to improve hue of formed dyes and whiteness of the white background, more specifically the density and color of unexposed areas of the silver halide color photographic material. Specifically unfavorable whiteness of the white background not only deteriorates lightness and color of highlight portions but also color contamination in portions in which formed dyes are present, resulting in deteriorated image quality and becoming a factor of lowering visual contrast of an image in which colored and uncolored portions are concurrently present.

To realize a silver halide color photographic material resulting in preferred whiteness, it is essential to lower fogging of the silver halide emulsion itself or to perform a design such that after processing, unnecessary colored material such as sensitizing dyes does not remain within the photographic material.

To overcome the foregoing problems, technical studies have been continued, for example, and proposed, for example, a method in which the use of white pigments or dyes controlled the color developing time to improve white characteristics, as disclosed in JP-A Nos. 6-39936, 6-59421 and 6-202291 (hereinafter, the term, JP-A refers to Japanese Patent Application Publication).

On the other hand, to lower fogging of silver halide, it is important to restrain an increase of fogging not only immediately after manufacturing a silver halide color photographic material but also durin the storage after manufacturing, up to the time of exposure or processing.

As a means for restraining fogging during storage of silver halide color photographic material, there were proposed a method of using an antifoggant having a specific structure to inhibit fogging as disclosed, for example, in JP-A No. 62-215272; a method of using catechols or hydroquinones to inhibit fogging as disclosed, for example, in JP-A No. 11-143011; and a method of using a water-soluble reducing agent having a specific structure to inhibit fogging as disclosed, for example, in JP-A No. 11-102045.

To reduce fogging due to natural radiation when storing a silver halide color photographic material having improved whiteness over the long-term, there were disclosed a method in which silver halide grains having an average grain size of not more than 0.70 μm were used in a yellow image forming layer, and a method in which the silver coating weight of a yellow image forming layer was designed to be within the range of 0.1 to 0.23 g/m², as described, for example, in JP-A No. 2003-43644 and U.S. Patent No. 2003/87210.

However, it was proved that improved effects achieved by the foregoing techniques were insufficient and specifically, it was insufficient to inhibit fogging caused by natural radiation after storage of a silver halide color photographic material over the long-term. An increase in fogging due to natural radiation is a phenomenon that is not caused in digital image outputting materials, other than a silver halide color photographic material. To enhance competitiveness against other image outputting materials, there was desired a silver halide color photographic material exhibiting superior resistance to natural radiation and superior stability even when stored over the long-term.

### SUMMARY OF THE INVENTION

In view of the foregoing, it is an object of the invention to provide a silver halide color photographic material exhibiting enhanced sensitivity and minimized variation in fog density even when stored over the long-term, resulting in a broad color density region and reduced color density difference caused by the difference in exposure time, which is suitable for print material used for digital image information, and an image forming method by use thereof.

The foregoing object of the invention can be achieved by the following constitution.

Thus, in one aspect the present invention is directed to a silver halide color photographic material comprising on a reflective support a yellow image forming layer, a magenta image forming layer and a cyan image forming layer, each of which contains silver halide grains having a chloride content of not less than 90 mol %, wherein a fog density of A(λ) and a maximum density of B(λ) at a wavelength of λ nm (in which λ=450 nm, 550 nm or 650 nm) of the photographic material which has been subjected to imagewise exposure and color processing, and a fog density of A′(λ) at a wavelength of λ nm (λ=450 nm, 550 nm or 650 nm) of the photographic material which has been subjected to overall exposure to radiation of 300 mR and further to the foregoing imagewise exposure and color processing satisfy the following equations (I), (II) and (III):
B(450)/[A′(450)−A(450)]≧60 (I)
B(550)/[A′(550)−A(550)]≧160 (II)
B(650)/[A′(650)−A(650)]≧260 (III).

In another aspect the invention is directed to an image forming method wherein the silver halide color photographic material described above is exposed through scanning exposure and then, within 0.1 to 30 sec., the exposed photographic material is subjected to color development for 5 to 30 sec.

Preferred embodiments of the invention are disclosed in the dependent claims.

### DETAILED DESCRIPTION OF THE INVENTION

A silver halide color photographic material of the invention (hereinafter, also denoted simply as photographic material) is comprised of a silver halide emulsion layer containing an yellow dye forming coupler, a silver halide emulsion layer containing a magenta dye forming coupler and a silver halide emulsion layer containing a cyan dye forming coupler on a support. The silver halide emulsion layer containing an yellow dye forming coupler, the silver halide emulsion layer containing a magenta dye forming coupler and the silver halide emulsion layer containing a cyan dye forming coupler on a support each function as an yellow image forming layer, a magenta image forming layer and a cyan image forming layer, respectively. The silver halide emulsions contained in the respective yellow image forming layer, magenta image forming layer and cyan image forming layer are preferably photosensitive to light in the wavelength region different each from the other (for example, lights of the blue region, the green region and the red region). In addition to the foregoing yellow image forming layer, magenta image forming layer and cyan image forming layer, the photographic material may optionally have a hydrophilic colloid layer, an antihalation layer, an interlayer or a tinted layer.

One feature of the silver halide color photographic material is that when a fog density of an unexposed area and a maximum density of the photographic material having imagewise exposed and processed are respectively designated as A(λ) and B(λ) at a wavelength of λ nm (λ=450 nm, 550 nm or 650 nm) and a fog density of an unexposed area of the photographic material having overall exposed to radiation of 300 mR, imagewise exposed and processed is designated as A′(λ) at a wavelength of λ nm (λ=450 nm, 550 nm or 650 nm), at least one the foregoing equations (I) to (III) is satisfied. The foregoing densities A(λ) and B(λ) at a wavelength of λ nm refer to fog and maximum densities which are determined at the wavelength of λ nm, and the fog density A′(λ) at a wavelength of λ nm refers to a fog density which is determined at the wavelength of λ nm.

Thus, the yellow image forming layer meets the requirement of B(450)/[A′(450)−A(450)]≧60, as defined in the foregoing equation (I) with respect to yellow density, and preferably B(450)/[A′(450)−A(450)]≧90, as defined in the foregoing equation (I′); and/or the magenta image forming layer meets the requirement of B(550)/[A′(550)−A(550)]≧160, as defined in the foregoing equation (II) with respect to magenta density, and preferably B(550)/[A′(550)−A(550)]≧240, as defined in the foregoing equation (II′); and/or the cyan image forming layer meets the requirement of B(650)/[A′(650)−A(650)]≧260, as defined in the foregoing equation (III) with respect to yellow density, and preferably B(650)/[A′(650)−A(650)]≧360, as defined in the foregoing equation (III′).

In the silver halide color photographic material of the invention, the fog density A(λ) at the respective wavelengths of λ (λ=450 nm, 550 nm and 650 nm) of an unexposed area of the photographic material having subjected to imagewise exposure and color processing, and the fog density A′(λ) at the respective wavelengths of λ (λ=450 nm, 550 nm and 650 nm) of an unexposed area of the photographic material having subjected to overall exposure to radiation of 300 mR, imagewise exposure and color processing are each the less, it is the more preferable in terms of characteristics of the white background, and the less the difference between A′ value and A value, an increase of fog density due to radiation is the less.

The fog density A(λ) of an unexposed area at a wavelength of λ nm is measured as a reflection absorbance which is obtained by measuring a processed sample at an aperture ratio of an integrating sphere of 2% and a slit width of 5=m with removing specular light under the condition of 25° C. and 50% RH. Examples of an apparatus for measurement of reflection absorbance include spectrophotometer U-3410 type, produced by Hitachi Seisakusho Co., Ltd. The maximum density B(λ) and fog density A′(λ) of an unexposed area after exposure to radiation at a wavelength of λ nm can be determined similarly to the A(λ).

As color processing, color processing recommended by each maker is applicable to silver halide color photographic material. For example, Process RA-4 series processing (produced by Eastman Kodak Co.) or Process CPK series processing (produced by Konica Minolta Photo-imaging Co.) is applicable to color print paper as silver halide color photographic material, as exemplified later. Further, here are also usable commonly known developers described in T. H. James, The Theory of the Photographic Process, Forth edition page 291-334; Journal of the American Chemical Society, vol. 73. No. 3, page 100 (1951). Processing can be carried out by conventional methods, as described in Research Disclosure (hereinafter, also denoted simply as RD) 17643, page 28-29, RD 18716 page 615 and RD 308119, XIX.

The fog density A(λ) of an unexposed area and the maximum density B(λ) can be determined, for example, in such a manner that after a silver halide color photographic material is exposed through an optical wedge having stepwise varied densities and processed in the foregoing color processing, an unexposed area corresponding to approximately 0% a transmittance of the optical wedge and the color density of the maximum exposure area (maximum color density), corresponding to approximately 100% of a transmittance of the wedge are measured. The fog density A′(λ) of an unexposed area can be determined similarly to the foregoing A(λ), provided that prior to color processing, the photographic material is exposed to radiation at an exposure dose of 300 mR using 137 Cs as a radiation source.

In the silver halide color photographic material of the invention, a means for achieving at least one of the requirement defined in the equations (I) to (III) or at least one of the requirement defined in the equations (I′) to (III′) is not specifically limited. For example, the fog density A(λ) of an unexposed area of the respective image forming layers is achieved preferably by an appropriate selection from or combination of a halide composition, grain size, grain shape and chemical sensitization conditions of silver halide grains of a silver halide emulsion used, and conditions such as a fog inhibitor or stabilizer, a coating weight of silver, a sensitizing dye amount, a binder amount and a hardening degree. The fog density A′(λ) of an unexposed area after exposed to a radiation of 300 mR is achieved preferably by an appropriate selection from or combination of the grain size and chemical sensitization conditions of silver halide grains, a coating weight of silver and a sensitizing dye amount of the foregoing control factors of the A(λ). The desired requirement for the maximum color density B(λ) can be achieved preferably by an appropriate selection from or combination of the kind or amount of a coupler and the grain size or composition of silver halide grains.

In one aspect of the silver halide color photographic material of the invention, each of the image forming layers contains a silver halide grain emulsion having a chloride content of not less than 90 mol %. Thus, silver halide grains of the silver halide emulsion have a chloride content of not les than 90 mol %, preferably not less than 93 mol %, and more preferably not less than 95 mol %. The silver halide grains preferably have an iodide content of from 0.05 to 2 mol %, and more preferably from 0.05 to 1 mol %.

The silver halide grains relating to this invention preferably have at least one iodide-localized silver halide phase in the interior of the grains in terms of lessening contrast reduction in the higher density region of a characteristic curve when exposed at a high intensity for a short period. In the invention, the interior of the grains refers to a silver halide phase, except for the grain surface. The iodide-localized silver halide phase (hereinafter, also denoted as iodide-localized phase) is a silver halide phase having at least two times the average iodide content of the grains, preferably at least three times the average iodide content, and more preferably at least 5 times the average iodide content. The iodide-localized phase is located in a portion external to 60% (preferably 70%, and more preferably 80%) of the grain volume within the grain. In other words, the iodide-localized phase is located in an exterior region outside the interior region accounting for at least 60% of the total silver forming the grains. The iodide-localized phase is located in a portion external to preferably 70%, and more preferably 80% of the grain volume within the grain. In one preferred embodiment, the iodide-localized phase exists in the form of a layer in the interior of the grain (which is hereinafter also called iodide-localized layer) and the iodide-localized layer preferably composed of at least two layers, in which the main layer is introduced according to the conditions described above and at least one layer (hereinafter, called a sub-layer) having an iodide content less than the maximum iodide content is introduced closer to the grain surface than the main layer. Iodide contents of the main layer and sub-layer can be chosen in accordance with the objective. Preferably, the main layer has an iodide content as high as possible and the sub-layer has an iodide content lower than the main layer from the viewpoint of latent image stability. In another preferred embodiment, the iodide-localized phase, which exists in the vicinity of corners or edges of the grain can be used in combination with the foregoing iodide-localized phase.

Silver halide grains of the silver halide emulsion preferably have a bromide content of from 0.1 10 mol %, more preferably from 0.5 to 8 mol %, and still more preferably from 1 to 8 mol %.

A silver halide emulsion comprising silver halide grains having a high bromide portion within the grain is also preferred in this invention. The high bromide portion may be formed by an epitaxial junction or by forming a core/shell structure. Alternatively, there may exist regions partially differing in bromide composition without forming a complete layer. The bromide composition may be continuously varied or discontinuously varied, and silver halide grains having a bromide-localized phase in the vicinity of corners of the grain are preferred. The expression bromide-localized phase herein means a silver halide phase having a relatively high bromide content. Thus, the bromide-localized phase has a bromide content of at least two times the average bromide content of the grains, preferably at least three times and more preferably at least 5 times the average bromide content. The bromide-localized phase preferably contains a Group 8 metal compound, as described later. The Group 8 metal compound is preferably an iridium complex compound.

In the silver halide grain emulsion containing an iodide, a coefficient of variation of iodide contents among grains is preferably less than 40%, more preferably less than 30% and still more preferably less than 20%. In the silver halide grain emulsion containing a bromide, a coefficient of variation of bromide contents among grains is preferably less than 30%, and more preferably less than 20%.

The bromide content and iodide content of silver halide grains can be determined in the EPMA method (Electron Probe Micro Analyzer method). Thus, silver halide grains are dispersed so as to not be in contact with each other to prepare a sample. The sample is irradiated with an electron beam, while cooling at a temperature of not more than 100° C. using liquid nitrogen, and the characteristic X-ray intensities of silver, bromine and iodine, radiated from a single silver halide grain are measured to determine iodide and bromide contents of the grain.

According to the method described above, bromide contents are determined for at least 300 silver halide grains and an averaged value thereof is defined as an average bromide content. A coefficient of variation of bromide contents among silver halide grains can be determined according to the following equation:
coefficient of variation of bromide contents among grains (%)=[(standard deviation of bromide content of silver halide grains)/(average bromide content)]×100.

Similarly, iodide contents are determined for at least 300 silver halide grains and an averaged value thereof is defined as an average iodide content. A coefficient of variation of iodide contents among silver halide grains can be determined according to the following equation:
coefficient of variation of iodide contents among grains (%)=[(standard deviation of iodide content of silver halide grains)/(average iodide content)]×100.

There can be used various iodine compounds to allow silver iodide to be contained in silver halide grains. Examples thereof include the use of an aqueous iodide salt solution, such as an aqueous potassium iodide solution, the use of a polyiodide compound, as described in S. Nakahara “Mukikagobutsu•Sakutai Jiten” (Dictionary of Inorganic Compound and Complex, page 944, published by Kodan-sha) and the use of fine iodide-containing silver halide grains or iodide ion-releasing agents, as disclosed in JP-A No. 2-68538. The use of an aqueous iodide salt solution, fine iodide-containing silver halide grains or iodide ion-releasing agents is preferred, the use of iodide ion-releasing agents is more preferred, and the use of iodide ion-releasing compounds described in JP-A No. 11-271912 is specifically preferred. The iodide content of silver halide grains and the iodide content of an iodide-localized phase can arbitrarily be controlled by adjusting the concentration or the quantity of an iodide containing solution.

There can also be used various bromide compounds to allow silver bromide to be contained in silver halide grains. Examples thereof include the use of an aqueous bromide salt solution, such as an aqueous potassium bromide solution, the use of bromide-containing silver halide fine-grains or bromide ion-releasing agents, as disclosed in JP-A No. 2-68538. Of these, use of an aqueous bromide salt solution, fine bromide-containing silver halide grains or bromide ion-releasing agents is preferred, the use of bromide ion-releasing agents is more preferred, and the use of bromide ion-releasing compounds described in JP-A No. 11-271912 is specifically preferred. The bromide content of silver halide grains and the bromide content of a bromide-localized phase can arbitrarily be controlled by adjusting the concentration or the quantity of an bromide containing solution.

When allowing silver iodide and/or silver bromide to be contained in a silver halide phase by supplying silver halide fine-grains, the silver halide fine-grains preferably have an average grain size of not more than 0.05 μm, more preferably from 0.001 to 0.03 μm, and still more preferably from 0.001 to 0.02 μm. The silver halide fine-grains are prepared preferably using a low molecular weight gelatin having an average molecular weight of 40,000 or less, more preferably from 5,000 to 25,000, and still more preferably from 5,000 to 15,000. The silver halide fine-grains are prepared preferably at a temperature of not more than 40° C., more preferably not more than 30° C., and still more preferably from 5 to 20° C. The silver halide fine-grains can be prepared by commonly known methods and apparatuses and the use of a continuous nucleation apparatus described in JP-A No. 2000-112049 is specifically preferred.

Silver halide grains of the silver halide emulsion of the invention preferably contain, in the interior of the grains, a compound represented by the following formula (S): 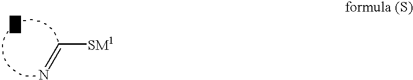
wherein Q is an atomic group necessary to form a 5- or 6-membered nitrogen-containing ring; M¹ is a hydrogen atom, an alkali metal or a group forming a monovalent cation (or a monovalent cation group).

The compound of formula (S) is preferably a compound represented by the following formula (S-2): 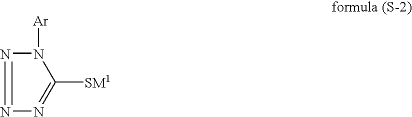
wherein Ar is a group represent by the following formula: 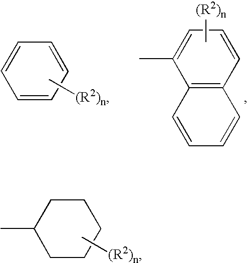
wherein R² is an alkyl group, an alkoxy group, a carboxy group or its salt, a sulfo group or its salt, a hydroxy group, an amino group, an acylamino group, a carbamoyl group or a sulfonamido group; n is an integer of 0 to 2; M¹ is the same as defined in the foregoing formula (S).

In the foregoing, the interior of the grains refers to a silver halide phase except the surface of the silver halide grains.

The compounds represented by formula (S) include compounds described, for example, in JP-B No. 40-28496, JP-A 50-890341; J. Chem. Soc. 49, 1748 (1927), ibid 4237 (1952); J. Org. Chem. 39, 2469 (1965); U.S. Pat. No. 2,824,001; J. Chem. Soc. 1723 (1951); JP-A No. 56-111846; U.S. Pat. Nos. 1,275,701, 3,266,897, 2,403,927, and can be synthesized in accordance with the synthesis described in the foregoing literature.

The content of the compound of formula (S), contained in the interior of silver halide grains, is preferably from 1×10⁻⁸ to 1×10⁻¹ mol/mol AgX, and more preferably from 1×10⁻⁷ to 1×10⁻² mol/mol AgX.

Silver halide grains of the invention preferably are regular crystal grains having dislocation lines in the fringe portion of the grains. Thus, silver halide grains having dislocation lines in the fringe portion preferably account for at least 50% by number of total silver halide grains, more preferably at least 70% and still more preferably at least 80% by number. When a cubic grain relating to the invention is projected from the direction vertical to (100) face of the grain, the fringe portion includes edges of the projection and is a region of from the edge to a length of 20% of the grain diameter in the inner direction vertical to the edge.

In the silver halide emulsion of the invention, preferably, silver halide grains having at least 5 dislocation lines in the fringe portion account for at least 50% by number of total silver halide grains; more preferably, silver halide grains having at least 10 dislocation lines in the fringe portion account for at least 50% by number of total silver halide grains; and still more preferably silver halide grains having at least 20 dislocation lines in the fringe portion account for at least 50% by number of total silver halide grains. The silver halide grains each may contain dislocation lines in a portion other than the fringe portion.

The dislocation lines in silver halide grains can be directly observed by means of transmission electron microscopy at a low temperature, for example, in accordance with methods described in J. F. Hamilton, Phot. Sci. Eng. 11 (1967) 57 and T. Shiozawa, Journal of the Society of Photographic Science and Technology of Japan, 35 (1972) 213. Silver halide grains are taken out from an emulsion while making sure not to exert any pressure that might cause dislocation in the grains, and they are then placed on a mesh for electron microscopy. The sample is then observed by transmission electron microscopy, while being cooled to prevent the grain from being damaged by the electron beam. Since electron beam penetration is hampered as the grain thickness increases, sharper observations are obtained when using an electron microscope of higher voltage (e.g., at a voltage 200 kV or more for a 0.25 μm thick grain). It is preferred to employ an electron microscope having a still higher acceleration voltage for further thicker grains.

When transmission observation by an electron beam is difficult due to grain thickness, a silver halide grain may be sliced parallel to a (100) face at not more than 0.25 μm thick, while paying close attention so as not to apply pressure to the extent of causing dislocation and the presence/absence of dislocation line can be confirmed by observation of the slice.

In the silver halide grains of this invention, the coefficient of variation of the number of dislocation lines per grain among grains preferably is not more than 30% and more preferably not more than 20%. The coefficient of variation of the number of dislocation lines can be determined by observation of dislocation lines of at least 300 silver halide grains, based on the following equation:
K(%)=(σ/α)×100
where K is the coefficient of variation among grains with respect to the number of dislocation lines per grain, σ is the standard deviation of dislocation lines and α is the average value of dislocation lines per grain.

Dislocation lines can be introduced into silver halide grains by employing an operation of formation of an iodide-localized phase and/or a bromide-localized phase by the use of the various iodine compounds and/or bromides described above. Examples thereof include the use of an aqueous iodide salt solution, such as an aqueous potassium iodide solution, the use of a polyiodide compound, as described in S. Nakahara “Mukikagobutsu•Sakutai Jiten” (Dictionary of Inorganic Compound and Complex, page 944, published by Kodan-sha) and the use of iodide-containing silver halide fine-grains or iodide ion-releasing agents, as disclosed in JP-A No. 2-68538. The use of iodide ion-releasing agents and/or bromide ion-releasing agents is preferred, the use of iodide ion-releasing agents is more preferred, and the use of iodide ion-releasing compounds and/or bromide ion-releasing compounds described in JP-A Nos. 11-271912 and 2000-250164 is specifically preferred.

The number of dislocation lines within the grain and the region forming dislocation lines can be optimally controlled by optimum selection of the addition amount of the foregoing iodide ion-releasing compounds and/or bromide ion-releasing compounds, the pH value causing iodide ion and/or bromide ion release, the inter-grain distance of silver halide grains, the growth temperature of silver halide grains and the rate of releasing iodide ions and/or bromide ions.

In the process of formation of silver halide grains, the iodide ion-releasing agent and/or bromide ion-releasing agent are added preferably within 50% to 98% of the final grain volume, and more preferably 70% to 95%. In other words, the iodide ion-releasing agent and/or bromide ion-releasing agent are added preferably after adding 50% of total silver and before adding 98% of total silver, and more preferably after adding 70% of total silver and before adding 95% of total silver. The iodide ion-releasing agent and/or bromide ion-releasing agent are added preferably in an amount of 0.02 to 8 mol % based on silver halide, and more preferably 0.04 to 5 mol %. The pH causing the iodide ion-releasing agent and/or bromide ion-releasing agent to release iodide ion and/or bromide ion is preferably from 5.0 to 12.0, and more preferably from 6.0 to 11.0. The temperature causing the iodide ion-releasing agent and/or bromide ion-releasing agent to release iodide ion and/or bromide ion is preferably from 10 to 80° C., and more preferably from 20 to 70° C. Preferably, concentration by ultrafiltration is conducted to optionally control the inter-grain distance at the time of causing the iodide ion-releasing agent and/or bromide ion-releasing agent to release iodide ion and/or bromide ion. At least two kinds of the iodide ion-releasing agent and/or bromide ion-releasing agent may be used in combination.

The silver halide grains may have any shape but cubic grains having a (100) face as the crystal surface. Further, octahedral, tetradecahedral, tetracosahedral or dodecahedral grains are also usable, which can be prepared according to methods described in U.S. Pat. Nos. 4,183,756 and 4,225,666; JP-A No. 55-26589 and JP-B No. 55-42737 (hereinafter, the term, JP-B refers to Japanese patent Publication); J. Photogr. Sci., 21, 39 (1973). Furthermore, there may be used grains having twin plane(s) or tabular grains other than cubic rains.

The silver halide grains of the invention are preferably composed of grains of a single form. Two or more kinds of monodisperse silver halide emulsions may be incorporated to a single layer.

Silver halide grains usable in the invention are not specifically limited with respect to grain size, but the grain size is preferably from 0.1 to 5.0 μm, and more preferably from 0.2 to 3.0 μm. Cubic grains of 0.1 to 1.2 μm (more preferably 0.15 to 1.0 μm) are preferred.

With respect to the grain size distribution, monodisperse silver halide grains exhibiting a coefficient of variation of grain size of not more than 0.22 (preferably not more than 0.15 and more preferably not more than 0.1) are preferred.
coefficient of variation=S/R
where S is a standard deviation of grain size distribution, R is an average grain size. The grain size defined above is a diameter for a spherical silver halide grain and a diameter of a circle equivalent to the area of the projection a grain when the grain is cubic or in a shape other than sphere.

In one preferred embodiment of the invention, the silver halide color photographic material is comprised of a silver halide emulsion containing silver halide grains having a chloride content of at least 90 mol % and occluding, in the interior of the grains, at least one of a group 8 metal complex containing an aqua ligand and a group 8 metal complex containing an organic ligand.

The group 8 metal complex usable in this invention is preferably a complex of a metal selected from iridium, rhodium, osmium, ruthenium, cobalt and platinum, that is, a metal complex of iridium, rhodium, osmium, ruthenium, cobalt or platinum. The metal complex may be a six-coordinate complex, five-coordinate complex, four-coordinate complex or two-coordinate complex, and a six-coordinate complex and a four-coordinate complex are preferred. Of the foregoing group 8 metal complexes containing an aqua ligand and/or an organic ligand or both of them, an iridium metal complex is preferred.

Any ligand is usable and examples of a ligand include carbonyl ligand, fulminate ligand, thiocyanate ligand, nitrosyl ligand, thionitrosyl ligand, cyano ligand, water ligand [in which water as a ligand is called an aqua (or aquo-) ligand], halogen ligand, ligands of ammonia, a hydroxide, nitrous acid, sulfurous acid and a peroxide and organic ligands. Of these, it is preferred to contain at least one ligand selected from nitrocyl ligand, thionitrocyl ligand, cyano ligand, aqua ligand, halogen ligand and an organic ligand. In this invention, the organic ligand refers to a compound containing at least one of H—C, C—C and C—N—H bonds and capable of being coordinated with a metal ion. Preferred organic ligands usable in this invention include a compound selected from pyridine, pyrazine, pyrimidine, pyrane, pyridazine, imidazole, thiazole, isothiazole, triazole, pyrazole, furan, furazane, oxazole, isooxazole, thiophene, phenthroline, bipyridine and ethylenediamine, their ions and compounds substituted with the foregoing compounds.

Preferred examples of a group 8 metal complex containing at least an aqua ligand and/or an organic ligand are shown below but are by no means limited to these. Any counter cation is usable, including potassium ion, calcium ion, sodium ion ammonium ion. Counter anions for the metal complex include nitrate ion, halide ion and perchlorate ion.
(A-1) K[IrBr₅(H₂O)]
(A-2) K₂[IrBr₅(H₂O)]
(A-3) K₃[IrBr₅(H₂O)]
(A-4) K₄[IrBr₅(H₂O)]
(A-5) K[IrBr₄(H₂O)₂]
(A-6) [IrBr₄(H₂O)₂]
(A-7) [IrBr₃(H₂O)₃]
(A-8) [IrBr₃(H₂O)₃]Br
(A-9) K[IrCl₅(H₂O)]
(A-10) K₂[IrCl₅(H₂O)]
(A-11) K₃[IrCl₅(H₂O)]
(A-12) K₄ [IrCl₅ (H₂O)]
(A-13) K[IrCl₄(H₂O)₂]
(A-14) [IrCl₄(H₂O)₂]
(A-15) [IrCl₃(H₂O)₃]
(A-16) [IrBr₃(H₂O)₃]Cl
(A-17) [Ir(bipy)Cl₄]¹⁻
(A-18) [Ir(bipy)Br₄]¹⁻
(A-19) [Ir(bipy)₃]²⁺
(A-20) [Ir(py)₆]²⁺
(A-21) [Ir(phen)₃]²⁺
(A-22) [IrCl₂ (bipy)₂]⁰
(A-23) [Ir(thia)₆]²⁺
(A-24) [IrCl₅(thia)]²⁻
(A-25) [IrCl₄(thia)₂]¹⁻
(A-26) [IrCl₅(5-methylthia)]²⁻
(A-27) [IrCl₄(5-methylthia)₂]¹⁻
(A-28) [IrBr₅(thia)]²⁻
(A-29) [IrBr₄(thia)₂]¹
(A-30) [IrBr₅(5-methylthia)]²⁻
(A-31) [IrBr₄(5-methylthia)₂]¹⁻
(A-32) [Ir(phen)(bipy)₃]²⁺
(A-33) [Ir(im)₆]²⁺
(A-34) [IrCl₅(im)]²⁻
(A-35) [IrCl₄(im)₂]¹⁻
(A-36) [IrBr₅(im)]²⁻
(A-37) [IrBr₄(im)₂]¹⁻
(A-38) [Ir(NCS)₂(bipy)₂]⁰
(A-39) [Ir(CN) 2 (bipy)₂]⁰
(A-40) [IrCl₂(bipy)₃]⁰
(A-41) [IrCl₂(bipy)₂]⁰
(A-42) [Ir(phen)(bipy)₂]²⁺
(A-43) [Ir(NCS)₂(bipy)₂]⁰
(A-44) [Ir(NCS)₂(bipy)₂]⁰
(A-45) [Ir(bipy)₂(H₂O) (bipy′)₂]⁰
(A-46) [Ir(bipy)₂(OH)(bipy′)]¹⁺
(A-47) [Ir(bipy)Cl₄]²⁻
(A-48) [Ir(bipy)₃]³⁺
(A-49) [Ir(py)₆]³⁺
(A-50) [Ir(phen)₃]³⁺
(A-51) [IrCl₂(bipy)₂]¹⁺
(A-52) [Ir(thia)₆]³⁺
(A-53) [Ir(phen)(bipy)₃]³⁺
(A-54) [Ir(im)₆]³⁺
(A-55) [Ir(NCS)₂(bipy)₂]¹⁺
(A-56) [Ir(CN)₂(bipy)₂]⁺
(A-57) [IrCl₂(bipy)₃]¹⁺
(A-58) [IrCl₂(bipy)₂]¹⁺
(A-59) [Ir(phen)(bipy)₂]
(A-60) [Ir(NCS)₂(bipy)₂]¹⁺
(A-61) [Ir(NCS)₂(bipy)₂]¹⁺
(A-62) [Ir(bipy)₂(H₂O)(bipy)]³⁺
(A-63) [Ir(bipy)₂(OH)(bipy′)]²⁺

In the foregoing group 8 metal compounds and group 8 metal complexes, abbreviation terms are as follows:
bipy: bipyridine bidendate ligand
bipy′: bipyridine monodendate ligand
im: imidazole
py: pyridine.
phen: phenthroline
thia: thiazole
5-methylthia: 5-methylthiazole.

Further to addition of at least a group 8 metal complex containing an aqua ligand and/or organic ligand in the preparation of silver halide grains, it is preferred to add a group 8 metal complex represented by the following formula:
Rₙ[MXₘY₆₋ₘ] formula (A)
wherein M is a metal selected from group 8 elements of the periodical table (preferably iron, cobalt, ruthenium, iridium, rhodium, osmium and platinum, and more preferably iron, ruthenium, iridium, rhodium, osmium); R is an alkali metal (preferably cesium, sodium and potassium); m is an integer of 0 to 6, and n is an integer of 0 to 4; X and Y are each a ligand, including carbonyl ligand, fulminate ligand, thiocyanate ligand, nitrosyl ligand, thionitrosyl ligand, cyano ligand, aqua ligand, halogen ligand, ligands of ammonia, a hydroxide, nitrous acid, sulfurous acid and a peroxide ligands.

Specific examples of the group 8 metal compound and group 8 metal complex are shown below but are by no means limited to these. Any counter cation is usable, including potassium ion, calcium ion, sodium ion ammonium ion. Counter anions for the metal complex include nitrate ion, halide ion and perchlorate ion.
E-1: K₂[IrCl₆]
E-2: K₃[IrCl₆]
E-3: K₂[Ir(CN)₆]
E-4: K₃[Ir(CN)₆]
E-5: K₂[Ir(NO)(CN)₅]
E-6: K₂[IrBr₆]
E-7: K₃[IrBr₆]
E-8: K₂[IrBr₄Cl₂]
E-9: K₃[IrBr₄Cl₂]
E-10: K₂ [IrBr₃Cl₃]
E-11: K₃ [IrBr₃Cl₃]
E-12: K₂[IrBr₅Cl]
E-13: K₃[IrBr₅Cl]
E-14: K₂[IrBr₅I]
E-15: K₃[IrBr₅I]
E-16: K₃[IrBr(CN)₅]
E-17: K₃[IrBr₂(CN)₄]
E-18: K₂[Ir(CN)₅(H₂O)]
E-19: K₃[Ir(CN)₅(H₂O)]
E-20: K[Ir(NO)Cl₅]
E-21: K[Ir(NS)Cl₅]
F-1: K₂[RuCl₆]
F-2: K₂[FeCl₆]
F-3: K₂[PtCl₆]
F-4: K₃[RhCl₆]
F-5: K₂[OsCl₆]
F-6: K₂[RuBr₆]
F-7: K₂[FeBr₆]
F-8: K₂[PtBr₆]
F-9: K₃[RhBr₆]
F-10: K₂[OsBr₆]
F-11: K₂[Pt(SCN)₄]
F-12: K₄[Ru(CNO)₆]
F-13: K₄[Fe(CNO)₆]
F-14: K₂[Pt(CNO)₄]
F-15: K₃[Co(NH₃)₆]
F-16: K₃[Co(CNO)₆]
F-17: K₄[Os(CNO)₆]
F-18: Cs₂[Os(NO)Cl₅]
F-19: K₂[Ru(NO)Cl₅]
F-20: K₂[Ru(CO)Cl₅]
F-21: Cs₂[Os(CO)Cl₅]
F-22: K₂[Fe(NO)Cl₅]
F-23: K₂[Ru(NO)Br₅]
F-24: K₂[Ru(NO)I₅]
F-25: K₂[Ru(NS)Cl₅]
F-26: K₂[Os(NS)Cl₅]
F-27: K₂[Ru(NS)Br₅]
F-28: K₂[Ru(NS)(SCN)₅]
F-29: K₂[RuBr₆]
F-30: K₂[FeBr₆]
F-31: K₄[Fe(CN)₆]
F-32: K₃[Fe(CN)₆]
F-33: K₄[Ru(CN)₆]
F-34: K₄[Os(CN)₆]
F-35: K₃[Rh(CN)₆]
F-36: K₄[RuCl(CN)₅]
F-37: K₄[OsBr(CN)₅]
F-38: K₄[OsCl(CN)₅]
F-39: K₃[RhF(CN)₅]
F-40: K₃[Fe(CO) (CN)₅]
F-41: K₄[RuF₂(CN)₄]
F-42: K₄[OsCl₂(CN)₄]
F-43: K₄[RhI₂(CN)₄]
F-44: K₄[Ru(CN)₅(OCN)]
F-45: K₄[Ru(CN)₅(N₃)₄]
F-46: K₄[Os(CN)₅(SCN)]
F-47: K₄[Rh(CN)₅(SeCN)]
F-48: K₄[RuF₂(CN)₄]
F-49: K₃[Fe(CN)₃Cl₃]
F-50: K₄[Os(CN)Cl₅]
F-51: K₃[Co(CN)₆]
F-52: K₂[RuBr(CN)₅]
F-53: K₂[Os(NS) (CN)₅]
F-54: K[Ru(NO)₂Cl₄]
F-55: K₄[Ru(CN)₅(N₃)₄]
F-56: K₂[Os(NS)Cl(SCN)₄]
F-57: K₂[Ru(NS)(I)₅]
F-58: K₂[Os(NS)Cl₄(TeCN)₄]
F-59: K₂[Rh(NS)Cl₅]
F-60: K₂[Ru(NO)(CN)₅]
F-61: K [Rh(NO)₂Cl₄]
F-62: K₂[Rh(NO)Cl₅]

To allow the foregoing Group 8 metal compounds to be included, doping may be conducted during physical ripening of silver halide grains or in the course of forming silver halide grains (in general, during addition of water-soluble silver salt and alkali halide). Alternatively, forming silver halide grains is interrupted and doping is carried out, then, the grain formation is continued. Doping can also be conducted by performing nucleation, physical ripening or grain formation in the presence of a Group 8 metal compound.

The Group 8 metal compound is used in an amount of 1×10⁻⁹ to 1×10⁻² mol, preferably 5×10⁻⁹ to 1×10⁻³ mol, and more preferably 1×10⁻⁸ to 1×10⁻⁴ mol per mol of silver halide. Commonly known methods of adding additives to a silver halide emulsion are applicable to allow the Group 8 metal compound to be included in silver halide grains, for example, the compound may be directly dispersed in an emulsion or incorporated through solution in solvents such as water, methanol and ethanol. A method of preparing a silver halide emulsion, in which fine silver halide grains including a Group 8 metal compound are added during grain formation can be referred to a method described in JP-A Nos. 11-212201 and 2000-89403.

It is preferred that the silver halide emulsion of this invention includes a gelatin which contains substantially no calcium ion. The gelatin which contains substantially no calcium ion is one having a calcium content of 100 ppm or less, preferably 50 ppm or less, and more preferably 30 ppm or less. A gelatin which contains substantially no calcium ion can be obtained by a cationic deionization process with ion-exchange resins. A gelatin which contains substantially no calcium ion is preferably used in at least one of the processes of silver halide grain formation, desalting, dispersion, and chemical sensitization and/or spectral sensitization, and more preferably prior to chemical sensitization and/or spectral sensitization. A gelatin which contains substantially no calcium ion preferably accounts for at least 10% by weight of the whole dispersing medium of a prepared silver halide emulsion, more preferably at least 30%, and still more preferably at least 50%.

A chemically modified gelatin of which amino group is substituted is preferably used in the preparation of a silver halide emulsion of this invention to perform the formation and/or desalting of silver halide grains. Examples of such a chemically modified gelatin include modified gelatins described in JP-A Nos. 5-72658, 9-197595 and 9-251193 in which an amino group of gelatin has been substituted. The use of a chemically modified gelatin in the process of grain formation and/or desalting is preferably in an amount of at least 10% by weight of the whole dispersing medium, more preferably at least 30%, and still more preferably at least 50%. The substitution ratio of an amino group is preferably at least 30%, more preferably at least 50%, and still more preferably at least 80%.

Preferably, a silver halide emulsion is desalted after completion of grain formation. Desalting is conducted in such a manner, for example, as described in RD 17643, sect. II. Specifically, to remove unwanted soluble salts from a precipitation product or a physically ripened emulsion, a noodle washing method may be used, or inorganic salts, anionic surfactants or anionic polymers [e.g., poly(styrene sulfonic acid)] are also usable, but a flocculation method using gelatin derivatives or chemically modified gelatin (e.g., acylated gelatin and carbamoylated gelatin) and a ultrafiltration method employing membrane separation are preferred. The ultrafiltration method employing membrane separation is referred to “Kagaku Kogaku Binran (Handbook of Chemical Engineering)” 5th ed., page 924-954; RD vol. 102, 10208 and vol. 131, 13122; JP-B Nos. 59-43727 and 62-27008; JP-A Nos. 62-113137, 57-209823, 59-43727, 61-219948, 62-23035, 62-113137, 63-40137, 63-40039, 3-140946, 2-172816, 2-172817 and 4-22942. Ultrafiltration is conducted preferably employing an apparatus or a method described in JP-A Nos. 11-339923 and 11-231448.

Dispersing medium used in the preparation of silver halide emulsions is a compound exhibiting a protective colloid property for silver halide grains. Preferably, the dispersing medium is allowed to exist in the nucleation and growth stages of silver halide grain formation. Preferred dispersing mediums usable in this invention include gelatin and hydrophilic colloids. Preferred examples of gelatin usable in this invention include an alkali process or acid process gelatin having a molecular weight of ca. 100,000, an oxidized gelatin, and enzymatic process gelatin described in Bull. Soc. Sci. Photo. Japan No. 16, page 30 (1966). A gelatin an average molecular weight of 10,000 to 50,000 is preferably used in the nucleation stage of silver halide grains. To reduce the average molecular weight, the use of a gelatin degradation enzyme or hydrogen peroxide degrade s gelatin. The use of a gelatin having a relatively low methionine content in the nucleation stage is preferred specifically in the preparation of silver halide grains. The methionine content is preferably not more than 50 μmol per unit weight (g) of dispersing medium, and more preferably not more than 20 μmol. The methionine content can be reduced by subjecting gelatin to an oxidation treatment by using hydrogen peroxide and the like.

Examples of a hydrophilic colloid include gelatin derivatives, a graft polymer of gelatin with other polymers, proteins such as albumin or casein; cellulose derivatives such as hydroxyethyl cellulose, carboxymethyl cellulose, cellulose sulfuric acid esters; saccharide derivatives such as sodium alginate and starch derivatives and synthetic hydrophilic polymeric materials of homopolymers such as polyvinyl alcohol and its partial acetal, poly-N-vinylpyrrolidone, polyacrylic acid, polymethacrylic acid, polyacrylamide, polyvinylimidazole, and polyvinylpyrazole and their copolymers. Examples of usable gelatin usable include an alkali process gelatin, acid process gelatin, an oxidized gelatin, and enzymatic process gelatin described in Bull. Soc. Sci. Photo. Japan No. 16, page 30 (1966). There are also usable hydrolytic products and enzymatic degradation products of gelatin.

There can be employed a variety of apparatuses and methods for preparing silver halide emulsions, which are generally known in the art. The silver halide can be prepared according to any of acidic precipitation, neutral precipitation and ammoniacal precipitation. Silver halide grains can formed through a single process, or through forming seed grains and growing them. A process for preparing seed grains and a growing process thereof may be the same with or different from each other. Normal precipitation, reverse precipitation, double jet precipitation or a combination thereof is applicable as a reaction mode of a silver salt and halide salt, and the double jet precipitation is preferred. As one mode of the double jet precipitation is applicable a pAg-controlled double jet method described in JP-A 54-48521.

There can be employed a apparatus for supplying a silver salt aqueous solution and a halide aqueous solution through an adding apparatus provided in a reaction mother liquor, as described in JP-A 57-92523 and 57-92524; an apparatus for adding silver salt and halide solutions with continuously varying the concentration thereof, as described in German Patent 2,921,164; and an apparatus for forming grains in which a reaction mother liquor is taken out from the reaction vessel and concentrated by ultra-filtration to keep constant the distance between silver halide grains.

Solvents for silver halide such as thioethers are optionally employed. A compound containing a mercapto group, nitrogen containing heterocyclic compound or a compound such as a sensitizing dye can also be added at the time of forming silver halide grains or after completion thereof.

Silver halide emulsions used in the silver halide color photographic material are usually subjected to chemical sensitization. Chemical sensitization is conducted by performing chalcogen sensitization, such as addition of labile sulfur compounds, noble metal sensitization such as gold sensitization or reduction sensitization, alone or in combination. Compounds used in chemical sensitization can be referred to JP-A No. 62-215272, from page 18, right lower-column to page 22, right upper-column. It is preferred to perform chemical sensitization (or chalcogen sensitization) using at least two chalcogen compounds.

Next, chemical sensitizers will be detailed. Labile sulfur compounds, labile selenium compounds and labile tellurium compounds are usable as a chalcogen compound. Specifically, the combined use of a labile sulfur compound and a labile selenium compound, or the combined use of a labile sulfur compound and a labile tellurium compound is preferred.

Labile selenium compounds capable of forming silver selenide upon reaction with aqueous silver nitrate are used as a selenium sensitizer. Examples thereof are described in U.S. Pat. Nos. 1,574,944, 1,602,592 and 1,623,499; JP-A Nos. 60-150046, 4-25832, 4-109240 and 4-147250. Examples of useful selenium sensitizers include colloidal selenium, isoselenocyanates (e.g., allyl isoselenocyanate), selenoureas (e.g., N,N-dimethylselenourea, N,N,N′-triethylselenourea, N,N,N′,N′-tetramethylselenourea, N,N,N′-trimethyl-N′-heptafluoropropylselenourea, N,N′-dimethyl-N,N′-bis(carboxymethyl)selenourea, N,N,N′-trimethyl-N′-heptafluoropropylcarbonylselenourea, N,N,N′-trimethyl-N′-4-nitrophenylcarbonylselenourea), selenoketones (e.g., selenoacetone, selenoacetophenone), selenoamides (e.g., selenoacetoamide, N,N-dimethylselenobenzamide), selenocarboxylic acids and selenoesters (e.g., 2-selenopropionic acid, methyl-3-selenobutylate), selenophosphates (e.g., tri-p-triselenophosphate, pentafluorophenyl-diphenylselenophosphate), and selenides (e.g., dimethylselenide, tributylphosphine selenide, triphenylphosphine selenide, tri-p-tolylphosphine selenide, pentafluorophenyl-diphenylphosphine selenide, trifurylphosphine selenide, tripyridylphosphine selenide) Of these selenium sensitizers.

Specific examples of technique for using selenium sensitizers are described in U.S. Pat. Nos. 1,574,944, 1,602,592, 1,623,499, 3,297,466, 3,297,447, 3,320,069, 3,408,196, 3,408,197, 3,442,653, 3,420,670, and 3,591,385; French Patent Nos. 2,693,038 and 2,093,209; JP-B Nos. 52-34491, 52-34492, 53-295 and 57-22090; JP-A Nos. 59-180536, 59-185330, 59-181337, 59-187338, 59-192241, 60-150046, 60-151637, 61-246738, 3-4221, 3-24537, 3-111838, 3-116132, 3-148648, 3-237450, 4-16838, 4-25832, 4-32831, 4-33043, 4-96059, 4-109240, 4-140738, 4-140739, 4-147250, 4-184331, 4-190225, 4-191729, 4-195035, 5-11385, 5-40324, 5-24332, 5-24333, 5-303157, 5-306268, 6-306269, 6-27573, 6-75328, 6-175259, 6-208184, 6-208186, 6-317867, 7-92599, 7-98483, 7-104415, 7-140579, 7-301879, 7-301880, 8-114882, 9-19760, 9-138475, 9-166841, 9-138475, 9-189979, 10-10666 and 2001-343721; British Patent Nos. 255,846 and 861,984; and H. E. Spencer, Journal of Photographic Science, 31, 158-169 (1983).

A selenium sensitizer is added preferably in an amount of 1×10⁻⁹ to 1×10⁻⁵ mol per mol of silver halide, and more preferably 1×10⁻⁸ to 1×10⁻⁵ mol. Selenium sensitizers are added to a silver halide emulsion in such a manner that additives are usually incorporated to photographic emulsion. For example, a water-soluble compound is dissolved in water and a water-insoluble or sparingly water-soluble compound is dissolved in a water-miscible solvent exhibiting no adverse effect on photographic characteristics, such as alcohols, glycols, ketones, esters, and amides, and they are added in the form of solution.

Examples of tellurium sensitizers usable in the invention include telluroureas (e.g., N,N-dimethyltellurourea, tetramethyltellurourea, N-carboxy-N,N′-dimethyltellurourea, N,N′-dimethyl-N′-phenyltellurourea), phosphine tellurides (e.g., tributylphosphine telluride, tricyclohexylphosphine telluride, tri-I-propylphosphine telluride, butyl-di-isopropylphosphine telluride, dibutylphenylphosphine telluride, tri-t-butylphosphine telluride, trimorpholylphosphine telluride), telluroamides (e.g., telluroamide, N,N-dimethyltelluroamide), and telluroketones, telluroesters, and isotellurocyanates.

Specific examples of preferred sulfur sensitizers include thiourea derivatives such as 1,3-diphenylthiourea, triethylthiourea and 1-ethyl-3-(2-thiazolyl)thiourea; rhodanine derivatives, dithiocarbamic acids, polysulfide organic compounds, thiosulfates, and simple substance of sulfur. Of simple substance of sulfur, rhombic α-sulfur is preferred. There are also usable sulfur sensitizers described in U.S. Pat. Nos. 1,574,944, 2,410,689, 2,278,947, 2,728,668, 3,501,313, and 3,656,955; West German Patent (OLS) No. 1,422,869; JP-A Nos. 56-24937 and 55-45016.

There may be simultaneously used noble metal salts such as gold, platinum, palladium and iridium described in Research Disclosure (hereinafter, also denoted simply as RD). Of these, the use of a gold sensitizer is specifically preferred. Examples of useful gold sensitizers include chloroauric acid, gold thiosulfate, gold thiocyanic acid and organic gold compounds described in U.S. Pat. Nos. 2,597,856 and 5,049,485; JP-B No. 44-15748 and JP-A Nos. 1-147537 and 4-70650. When performing sensitization by using a gold complex, ligands for gold, such as a thiosulfate, thiocyanate, and thioether are preferably used as an auxiliary agent and the use of a thiocyanate is specifically preferred.

As various chemical sensitizers as described above, inhibitors and oxidizing agents, there are preferably employed compounds and techniques described in JP-A No. 2001-318443; Japanese patent Application No. 2003-29472; JP-A Nos. 2004-37554, 2004-4144, 2004-4446, 2004-4452, 2004-4456, 2004-4458, 2004-656, 2004-4672, 2003-307803, 2003-287841, 2003-287842, 2003-233146, 2003-172990, 2003-172991, 2003-113193, 2003-113194, 2003-114489, 2002-372765, 2002-296721, 2002-278011, 2002-268169, 2002-244241, 2002-250982, 2002-258427, 2002-268168, 2002-268170, 2000-193942, 2001-75214, 2001-75215, 2001-75216, 2001-75217, 2001-75218, 2001-100352, 2004-70363, 2004-67695, 2002-131858, and 2001-166412; European patent No. 109460 and 138852; U.S. Pat. Nos. 6,686,143 and 6,322,961.

The addition amount of a chalcogen sensitizer or a gold sensitizer, depending on the kind of a silver halide grain emulsion, the kind of a used compound and ripening conditions, is preferably 1×10⁻⁹ to 1×10⁻⁵ mol per mol of silver halide, and more preferably 1×10⁻⁸ to 1×10⁻⁵ mol. Various sensitizes described above may be added in accordance with properties of a sensitizer, for example, by solution in water or organic solvents such as methanol, by a mixture with a gelatin solution or by a method described in JP-A No. 4-140739, i.e., addition in the form of emulsified dispersion of a solution mixed with a polymer soluble in an organic solvent.

Reduction sensitizers may be further used and reducing compounds described in RD vol. 307, 307105 and JP-A No. 7-78685 are usable.

Silver halide grains of the respective color image forming layers of the silver halide color photographic material are subjected to spectral sensitization to provide spectral sensitivity in the desired wavelength region.

The silver halide color photographic material comprises layer(s) containing silver halide emulsion(s) which are spectrally sensitized in the wavelength region of 400 to 900 nm, in combination with a yellow coupler, a magenta coupler and a cyan coupler. The silver halide emulsion contains one or more kinds of sensitizing dyes, singly or in combination thereof. Spectral sensitizing dyes for used in spectral sensitization for the blue-sensitive, green-sensitive and red-sensitive regions include, for example, those described in F. M. Harmer, Heterocyclic Compounds, Cyanine dyes and related compounds (John Wiley & Sons, New York, London, 1964).

In the silver halide emulsions can be employed a variety of spectral-sensitizing dyes known in the art. Compounds BS-1 to 8 described in JP-A 3-251840 at page 28 are preferably employed as a blue-sensitive sensitizing dye. Compounds GS-1 to 5 described in JP-A 3-251840 at page 28 are preferably employed as a green-sensitive sensitizing dye. Compounds RS-1 to 8 described in JP-A 3-251840 at page 29 are preferably employed as a red-sensitive sensitizing dye. In cases where exposed to infrared ray with a semiconductor laser, infrared-sensitive sensitizing dyes are employed. Compounds IRS-1 to 11 described in JP-A 4-285950 at pages 6-8 are preferably employed as a blue-sensitive sensitizing dye. Supersensitizers SS-1 to SS-9 described in JP-A 4-285950 at pages 8-9 and compounds S-1 to S-17 described in JP-A 5-66515 at pages 5-17 are preferably included, in combination with these blue-sensitive, green-sensitive and red-sensitive sensitizing dyes. The sensitizing dye is added at any time during the course of silver halide grain formation to completion of chemical sensitization. The addition amount of a sensitizing dye is variable over a broad range and preferably from 0.5×10⁻⁶ to 1×10⁻² mol per mol of silver halide, and more preferably from 1.0×10⁻⁶ to 5.0×10⁻³ mol.

In the photographic material of the invention, wherein silver halide grains contained in at least one of the yellow, magenta and cyan image forming layers are spectrally sensitized with a sensitizing dye, preferably in an amount satisfying at least one of the following equations (VII), (VIII) and (IX):
VY>3.2×10⁻⁴/LY (VII)
VM>2.3×10⁴/LM (VIII)
VC>0.6×10⁻⁴/LC (IX)
wherein VY, VM and VC represents an amount (mol/Ag mol) of the sensitizing dye contained in each of the yellow, magenta and cyan image forming layers, respectively; and LY, LM and LC represents an average grain size (μm) of silver halide grains contained in each of the yellow, magenta and cyan image forming layers.

Thus, when sensitizing dyes are added to yellow, magenta and cyan image forming layers in an amount of VY, VM and VC (mol/Ag mol), respectively, and the average silver halide grain size of the respective color image forming layers are designated as LY, LM and LC (μm), the yellow image forming layer preferably meets the requirement of VY>3.2×10⁻⁴/LY (more preferably VY≧3.5×10⁻⁴/LY), the magenta image forming layer preferably meets the requirement of VM>2.3×10⁻⁴/LM (more preferably VM≧2.5×10⁻⁴/LM), and the cyan image forming layer preferably meets the requirement of VC>0.6×10⁻⁴/LC (more preferably VY≧0.8×10⁻⁴/LC).

It is preferred that in at least one of yellow, magenta and cyan image forming layers of the photographic material, adding sensitizing dyes so as to meet the foregoing requirements achieves the condition defined in the equations (I) to (III) or equations (I′) to (III′).

Sensitizing dyes are added to a silver halide emulsion in accordance with methods known I the art. For example, sensitizing dyes may be dispersed directly in the emulsion, or may be dissolved in water-soluble solvents such as pyridine, methyl alcohol, ethyl alcohol, methyl cellosolve, acetone, fluorinated alcohol, dimethylformamide or their mixture, or diluted with or dissolved in water, and the obtained solution is added to the emulsion. Ultrasonic vibration may be employed in the course of solution.

There are also employed a method in which a dye is dissolved in a volatile organic solvent and the obtained solution is dispersed in a hydrophilic colloid and the dispersion is added to the emulsion, as described in U.S. Pat. No. 3,469,987; and a method in which a water-insoluble dye is dispersed in a water-soluble solvent without being dissolved and the obtained dispersion is added to the emulsion, as described in JP-B No. 46-24185.

Dyes may be added to the emulsion in the form of a dispersion prepared by an acid-solution dispersion method. Addition to the emulsion can also achieved by methods described in U.S. Pat. Nos. 2,912,345, 3,342,605, 2,996,287 and 3,425,835.

Sensitizing dyes are added through solution in water-miscible organic solvents such as methanol, ethanol, fluorinated alcohol, acetone and dimethylformamide or water, or in the form of solid particle dispersion. Thus, a dye may be added at any time, for example, before or during formation of silver halide grains, at the time from completion of silver halide grain formation to the start of chemical sensitization, during chemical sensitization, or at the time of completion of chemical sensitization to coating. The dye may be separately added plural times.

There will be further described other constituent elements of the silver halide color photographic material.

A antifoggant or a stabilizer known in the art are incorporated into the photographic material, for the purpose of preventing fog produced during the process of preparing the photographic material, reducing variation of photographic performance during storage or preventing fog produced in development. Examples of preferred compounds for the purpose include compounds represented by formula (II) described in JP-A 2-146036 at page 7, lower column. Specific examples thereof include compounds (Iia-1) to (IIa-8) and (IIb-1) to (IIb-7) described therein (page 8), 1-(3-methoxyphenyl)-5-mercaptotetrazole and 1-(4-ethoxyphenyl)-5-mercaptotetrazole; compounds of formula (S), thiosulfonic acid compounds, disulfide compounds and polysulfide compounds described in JP-A No. 8-6201; compounds described in Japanese Patent Application Nos. 2003-29472, 2003-10482 and 2002-312557.

These compounds are added in the step of preparing a silver halide emulsion, the chemical sensitization step or during the course of from completion of chemical sensitization to preparation of a coating solution. In cases when chemical sensitization is undergone in the presence of these compounds, the amount thereof is preferably 1×10⁻⁸ to 5×10⁻⁴ mole per mole of silver halide. Methods of adding additives to photographic emulsion of coating solution, as known in the art are applicable to addition of these compounds. Specifically, water-soluble compounds are added through solution in water or water-insoluble or hardly water-soluble compounds are dissolved in a water-miscible organic solvent, for example, solvents not adversely affecting photographic characteristics, such as alcohols, glycols, ketones, esters and amides, and the formed solution is added.

There are employed dyes having absorption at various wavelengths for anti-irradiation and anti-halation in the photographic material relating to the invention. A variety of dyes known in the art can be employed, including dyes having absorption in the visible range described in JP-A 3-251840 at page 30, AI-1 to 11, and JP-A No. 6-3770; infra-red absorbing dyes described in JP-A No. 1-280750 at page 2, left lower column, formula (I), (II) and (III). These dyes do not adversely affect photographic characteristics of a silver halide emulsion and there is no stain due to residual dyes. For the purpose of improving sharpness, the dye is preferably added in an amount that gives a reflection density at 680 nm of 0.7 to 3.0 and more preferably 0.8 to 3.0.

Fluorescent brightening agents are also incorporated into the photographic material to improve whiteness. Examples of preferred compounds include those represented by formula II described in JP-A No. 2-232652.

As couplers used in silver halide photographic materials relating to the invention is usable any compound capable of forming a coupling product exhibiting an absorption maximum at the wavelength of 340 nm or longer, upon coupling with an oxidation product of a developing agent. Representative examples thereof include yellow dye forming couplers exhibiting an absorption maximum at the wavelength of 350 to 500 nm, magenta dye forming couplers exhibiting an absorption maximum at the wavelength of 500 to 600 nm and cyan dye forming couplers exhibiting an absorption maximum at the wavelength of 600 to 750 nm.

Examples of preferred cyan couplers include those which are represented by general formulas (C-I) and (C-II) described in JP-A 4-114154 at page 5, left lower column. Exemplary compounds described therein (page 5, right lower column to page 6, left lower column) are CC-1 to CC-9.

Examples of preferred magenta couplers include those which are represented by general formulas (M-I) and (M-II) described in JP-A No. 4-114154 at page 4, right upper column. Exemplary compounds described therein (page 4, left lower column to page 5, right upper column) are MC-1 to MC-11. Of these magenta couplers are preferred couplers represented by formula (M-I) described in ibid, page 4, right upper column; and couplers in which R_{M} in formula (M-I) is a tertiary alkyl group are specifically preferred. Further, couplers MC-8 to MC-11 are superior in color reproduction of blue to violet and red, and in representation of details.

Examples of preferred yellow couplers include those which are represented by general formula (Y-I) described in JP-A No. 4-114154 at page 3, right upper column. Exemplary compounds described therein (page 3, left lower column) are YC-1 to YC-9. Of these yellow couplers are preferred couplers in which RY1 in formula (Y-I) is an alkoxy group are specifically preferred or couplers represented by formula [I] described in JP-A No. 6-67388. Specifically preferred examples thereof include YC-8 and YC-9 described in JP-A No. 4-114154 at page 4, left lower column and Nos. (1) to (47) described in JP-A No. 6-67388 at pages 13-14. Still more preferred examples include compounds represented by formula [Y-1] described in JP-A No. 4-81847 at page 1 and pages 11-17.

When an oil-in-water type-emulsifying dispersion method is employed for adding couplers and other organic compounds used for the photographic material of the present invention, in a water-insoluble high boiling organic solvent, whose boiling point is 150° C. or more, a low boiling and/or a water-soluble organic solvent are combined if necessary and dissolved. In a hydrophilic binder such as an aqueous gelatin solution, the above-mentioned solutions are emulsified and dispersed by the use of a surfactant. As a dispersing means, a stirrer, a homogenizer, a colloidal mill, a flow jet mixer and a supersonic dispersing machine may be used. Preferred examples of the high boiling solvents include phthalic acid esters such as dioctyl phthalate, diisodecyl phthalate, and dibutyl phthalate; and phosphoric acid esters such as tricresyl phosphate and trioctyl phosphate. High boiling solvents having a dielectric constant of 3.5 to 7.0 are also preferred. These high boiling solvents may be used in combination. Instead of or in combination with the high boiling solvent is employed a water-insoluble and organic solvent-soluble polymeric compound, which is optionally dissolved in a low boiling and/or water-soluble organic solvent and dispersed in a hydrophilic binder such as aqueous gelatin using a surfactant and various dispersing means. In this case, examples of the water-insoluble and organic solvent-soluble polymeric compound include poly(N-t-butylacrylamide).

As a surfactant used for adjusting surface tension when dispersing or coating photographic additives, the preferable compounds are those containing a hydrophobic group having 8 through 30 carbon atoms and a sulfonic acid group or its salts in a molecule. Exemplary examples thereof include A-1 through A-11 described in JP-A No. 64-26854. In addition, surfactants, in which a fluorine atom is substituted to an alkyl group, are also preferably used. The dispersion is conventionally added to a coating solution containing a silver halide emulsion. The elapsed time from dispersion until addition to the coating solution and the time from addition to the coating solution until coating are preferably short. They are respectively preferably within 10 hours, more preferably within 3 hours and still more preferably within 20 minutes.

To each of the above-mentioned couplers, to prevent color fading of the formed dye image due to light, heat and humidity, an anti-fading agent may be added singly or in combination. The preferable compounds or a magenta dye are phenyl ether type compounds represented by Formulas I and II in JP-A No. 2-66541, phenol type compounds represented by Formula IIIB described in JP-A No. 3-174150, amine type compounds represented by Formula A described in JP-A No. 64-90445 and metallic complexes represented by Formulas XII, XIII, XIV and XV described in JP-A No. 62-182741. The preferable compounds to form a yellow dye and a cyan dye are compounds represented by Formula I described in JP-A No. 1-196049 and compounds represented by Formula II described in JP-A No. 5-11417.

A compound (d-11) described in JP-A No. 4-114154 at page 9, left lower column and a compound (A′-1) described in the same at page 10, left lower column are also employed for allowing the absorption wavelengths of a dye to shift. Besides can also be employed a compound capable of releasing a fluorescent dye described in U.S. Pat. No. 4,774,187.

It is preferable that a compound reacting with the oxidation product of a color developing agent be incorporated into a layer located between light-sensitive layers for preventing color staining and that the compound is added to the silver halide emulsion layer to decrease fogging. As a compound for such purposes, hydroquinone derivatives are preferable, and dialkylhydroquinone such as 2,5-di-t-octyl hydroquinone are more preferable. The specifically preferred compound is a compound represented by Formula II described in JP-A No. 4-133056, and compounds II-1 through II-14 described in the above-mentioned specification pp. 13 through 14 and compound 1 described on page 17.

In the photographic material according to the present invention, it is preferable that static fogging is prevented and light-durability of the dye image is improved by adding a UV absorber. The preferable UV absorbent is benzotriazoles. The specifically preferable compounds are those represented by Formula III-3 in JP-A No. 1-250944, those represented by Formula III described in JP-A No. 64-66646, UV-1L through UV-27L described in JP-A No. 63-187240, those represented by Formula I described in JP-A No. 4-1633 and those represented by Formulas (I) and (II) described in JP-A No. 5-165144.

In the photographic materials used in the invention is advantageously employed gelatin as a binder. Furthermore, there can be optionally employed other hydrophilic colloidal materials, such as gelatin derivatives, graft polymers of gelatin with other polymers, proteins other than gelatin, saccharide derivatives, cellulose derivatives and synthetic hydrophilic polymeric materials.

The total coating weight of gelatin of the constituent layers of the photographic material is preferably from 3 to 6 g/m², and more preferably from 3 to 6 g/m². The thickness of the overall constituent layers is preferably from 3 to 7.5 μm, and more preferably from 3 to 6.5 μm to satisfy progression of development, bleach-fixability and dye residue even when subjected to rapid processing. The dry layer thickness can be determined from the difference in thickness between before and after peeling a dry layer or by observation of the section using an optical microscope or an electron microscope. To achieve enhancements of progression of development and drying rate, the swollen layer thickness is preferably from 8 to 19 μm, and more preferably from 9 to 18 μm. The swollen layer thickness can be determined in such a manner that a dry photographic material is dipped into aqueous solution of 35° C. and after swelling equilibrium is reached, measurement is conducted by an intermittent method.

The total amount of silver contained in the image forming layers is preferably not more than 0.51 g/m², more preferably not more than 0.48 g/m², and still more preferably from 0.1 to 0.45 g/m². The total amount of silver contained in the yellow image forming layer is preferably not more than 0.23 g/m², and more preferably from 0.1 to 0.19 g/m².

A vinylsulfone type hardening agent or a chlorotriazine type hardening agent is employed as a hardener of the binder, and compounds described in JP-A No. 61-249054 and 61-245153 are preferably employed. An antiseptic or antimold described in JP-A No. 3-157646 is preferably incorporated into a hydrophilic colloid layer to prevent the propagation of bacteria and mold which adversely affect photographic performance and storage stability of images. Lubricants or matting agents, as described in JP-A No. 6-118543 and 2-73250 are also preferably incorporated to improve surface physical properties of raw or processed photographic materials.

A reflective support usable in the invention preferably contains white pigment in the water-resistant resin-coated layer on the image forming layer side of the support. Examples of a white pigment mixed with the water-resistant resin include inorganic pigments such as titanium dioxide, barium sulfate, lithopone, aluminum oxide, calcium carbonate, silicon oxide, and antimony trioxide, titanium phosphate, zinc oxide, white lead, and zirconium oxide; organic fine-powder of polystyrene or styrene-divinylbenzene copolymer. Of these pigments, the use of titanium dioxide is effective. Titanium dioxide may be either a rutile type or an anatase type, of which the anatase type is preferred when whiteness is a high priority, and the rutile type is preferred when sharpness is the priority. Taking whiteness and sharpness into account, the rutile type and the anatase type may be blended. It is also preferred that when the water-resistant layer is formed of plural layers, the anatase type is included in one layer and the rutile type is included in another layer. The foregoing titanium dioxide can be manufactured by either a sulfate method or a chloride method.

The water-resistant resin usable in the reflective support refers to a resin exhibiting a water absorption coefficient of not more than 0.5 (% by weight), and preferably not more than 0.1. Examples thereof include a polyolefin such polyethylene, polypropylene or polyethylene type polymers, a vinyl polymer or its copolymer (e.g., polystyrene, polyacrylate, their copolymers), and polyester (e.g., polyethyelene terephthalate, polyethylene isophthalate) and its copolymer. Of these, polyethylene and polyester are preferred. Examples of polyethylene include high density polyethylene, low density polyethylene, linear low density polyethylene and their blend.

Of polyesters, a polyester synthesized by condensation polymerization of a dicarboxylic acid and a diol. Preferred examples of a dicarboxylic acid include terephthalic acid, isophthalic acid and naphthalenedicarboxylic acid. Preferred examples of a diol include ethylene glycol, butylenes glycol, neopentylglycol, triethylene glycol, butanedio, hexylene glycol, ethylene oxide adduct of bisphenol A {or 2,2-bis[4-(2-hydroxyethyloxy)phenyl]propane} and 1,4-dihydroxymethylcyclohexane. There are usable various polyesters obtained by condensation polymerization of the foregoing dicarboxylic acid, alone or its mixture and the foregoing diol, alone or its mixture. Specifically, at least one of dicarboxylic acids is preferably terephthalic acid.

The weight ratio of water-resistant resin/white pigment is preferably from 95/5 to 50/50, and more preferably from 90/10 to 60/40. The water-resistant resin layer is coated onto a substrate, preferably at a thickness of 2 to 200 μm, and more preferably at 5 to 80 μm. Resin or resin composition is coated on the opposite side of the substrate to the image forming layer, preferably at a thickness of 5 to 100 μm, and more preferably at 10 to 50 μm.

The water-resistant resin layer may contain a blueing agent to adjust the white background. Examples of a blueing agent usable in the invention include ultramarine blue, cobalt blue, oxidized phosphoric acid cobalt, and quinacrydone type pigments. The particle size of blueing agents is not specifically limited and the particle size of a commercially available blueing agent is usually from 0.3 to 10 μm and particles falling within this size range are acceptable in practice. When the water-resistant resin layer is multi-layered, the blueing agent content of the uppermost water-resistant resin layer is preferably more than that of any lower layer. The blueing agent content of the uppermost layer is preferably from 0.2% to 0.5% by weight and that of the adjacent lower layer is preferably from 0 to 0.45% by weight.

Examples of a substrate usable for a reflective support used in the invention include a natural pulp paper prepared from natural pulp as the main raw material, mixed paper comprised of natural pulp and synthetic fibers, synthetic fiber paper prepared from synthetic fibers as the main raw material, resin paper which is prepared by modifying synthetic resin such as polystyrene or polypropylene into a paper-like film, and plastic film, such as polyester film such as polyethylene terephthalate or polybutylene terephthalate, cellulose triacetate film, polystyrene film and polyolefin film such as polypropylene. Of these, natural pulp paper (hereinafter, also denoted as raw paper) is specifically preferred as a substrate of the water-resistant resin-coated support for photographic use. Dyes or fluorescent dyes may optionally be incorporated to modify whiteness of the background.

The thickness of the raw paper of the support is not specifically limited but preferably is from 50 to 250 g/m², in weight and from 50 to 250 μm, in thickness.

A reflective support having a polyolefin layer containing minute pores on the silver halide emulsion layer side of the substrate is more preferred. The polyolefin layer may be multi-layered, which is preferably composed of a polyolefin layer (e.g., polypropylene or polyethylene) adjacent to a gelatin layer of the silver halide emulsion layer side, containing no minute pore and a polyolefin layer (e.g., polypropylene or polyethylene) closer to the paper substrate and containing minute pores. Such a single or multi-layered polyolefin layer located between the paper substrate and the photographic component layer preferably has a density of 0.40 to 1.00 g/ml and more preferably 0.50 to 0.70 g/ml. This polyolefin layer preferably has a thickness of 10 to 100 μm, more preferably 15 to 70 μm. The thickness ratio of the polyolefin layer to the paper substrate is preferably from 0.05 to 0.20, more preferably from 0.10 to 0.15.

It is also preferred to provide a polyolefin layer on the opposite side (or back side) of the paper support from the image-forming layer, in terms of enhancement of rigidity of the reflective support, which is preferably composed of polyethylene or polypropylene (more preferably polypropylene) having a matted surface. The polyolefin layer of the back side is preferably from 5 to 50 μm thick, more preferably from 10 to 30 μm thick, and its density is preferably from 0.7 to 1.1 g/ml. Reflective supports usable in the invention, specifically with respect to preferred embodiments of a polyolefin layer provided on a paper substrate are described in, for example, JP-A Nos. 10-333277, 10-333278, 11-52513 and 11-65024; and European Patent Nos. 880,065 and 880,066.

The foregoing water-resistant resin layer preferably contains a brightener. Alternatively, a hydrophilic layer containing a brightener may be provided separately provided. Examples of a preferred brightener include benzoxazole type, coumalin type and pyrazoline type brighteners. Of these, the benzoxazolylnaphthalene type and benzoxazolylstilbene type brighteners are preferred. The brightener is used preferably at 1 to 100 mg/m². When incorporated into a water-resistant resin layer, the resin content is preferably from 0.0005% to 3% by weight, more preferably from 0.001% to 0.5%.

There may be used a reflective support provided with a hydrophilic colloid layer containing a white pigment on a transparent support or on the foregoing reflective support. A reflective support may be one having a mirror-reflective or second kind diffuse-reflective, metallic surface.

Next, there will be described a method of adjusting the white-background of silver halide color photographic material with a hydrophilic colloid layer forming a photographic component layer coated on the support.

Factors which deteriorate the white-background, due to the respective component layers, include, for example, fogging of the silver halide emulsion, residual sensitizing dyes and staining due to adsorption of processing solution. Reduction of such deteriorating factors can approach whiteness inherent to the support. Alternatively, incorporation of a dye or pigment incapable of being decolorized upon processing or addition of a brightener to a processed photographic material can control the white-background within the preferred range.

Next, there will be described pigments used for coloring hydrophilic colloid layers as a photographic component layer.

In the silver halide color photographic material, a pigment is contained (or dispersed) in at least one of silver halide emulsion layers and a light-insensitive layer provided on a reflective support. The pigment may be contained in any one of a light-sensitive layer containing a silver halide emulsion, an interlayer between silver halide emulsion layers, an ultraviolet absorbing layer located on the silver halide emulsion layer and a gelatin sublayer. A silver halide emulsion layer is coated with varying the coating amount so as to meet the desired characteristic curve, while to maintain constant coloring, it is often preferred to introduce a pigment into a light-insensitive layer.

Blue-tinting (or blueing) is provided to overcome yellow staining. Usually, it is done as tinting to incorporate a pigment in a sufficient quantity capable of competing with yellow stain to allow the human eye to perceive white as a neutral color. Further, the use of at least two pigments with varying their amount ratio enables correction of yellow stains over a wide range. In general, it is the combined use of a blue pigment which shifts hue toward cyan and a red or violet pigment which shifts the hue toward magenta, whereby it becomes possible to control tinting over a wide range. Any water-insoluble pigment is usable and one which is miscible with and readily dispersible in an organic solvent. The particle size of a pigment is preferably from 0.01 to 5.0 μm to achieve efficient tinting, more preferably from 0.01 to 3.0 μm.

In the embodiments of the invention, it is specifically preferred to introduce pigments in the following manner. Similarly to emulsifying photographically useful material such as conventional dye-forming couplers (hereinafter also denoted as couplers) and incorporating the emulsified dispersion into photographic material, a pigment is added to a high boiling solvent to form a homogeneous dispersion containing a fine-particular pigment. The thus formed dispersion is dispersed into a hydrophilic colloid, preferably, an aqueous gelatin solution together with a dispersing agent such as a surfactant, using a commonly known apparatus such as a ultrasonic homogenizer, a colloid mill, a homogenizer, a Manton-Gaulin homogenizer or a high-speed dissolver to obtain an emulsified dispersion. High boiling solvents usable in the invention are not specifically limited and commonly known ones are usable, as described in, for example, U.S. Pat. No. 2,322,027 and JP-A No. 7-152129. Auxiliary solvents are also used together with high boiling solvents. Examples of an auxiliary solvent include an acetate of a lower alcohol such as ethyl acetate or butyl acetate; ethyl propionate, sec-butyl acetate, methyl ethyl ketone, methyl isobutyl ketone, β-ethoxyethyl acetate, methyl cellosolve acetate, methylcarbitol acetate and cyclohexanone. It is specifically preferred to disperse a pigment in an organic solvent containing a photographically useful material such as a coupler to prepare a co-emulsified dispersion.

The foregoing will be further detailed based on examples but is not limited thereto unless otherwise noted. There is usable any kind of a pigment which is adjustable to the desired color and capable of remaining in photographic material without varying during processing. Although there are described preferable pigments based on specific examples, a blue pigment used in the invention refers to a pigment classified as C.I. Pigment Blue in the “Color Index” (The Society of Dyers and Colourists). Similarly, a red pigment used in the invention refers to a pigment classified as C.I. Pigment Red; and a violet pigment used in the invention refers to a pigment classified as C.I. Pigment Violet.

Examples of a blue pigment usable in the invention include an azo dye (e.g., C.I. Pigment Blue 25), a phthalocyanine pigment (e.g., C.I. Pigment Blue 15:1, the said 15:3, the said 15:6, the said 16, the said 75), an indanthrone dye (e.g., C.I. Pigment Blue 60, the said 64, the said 21), a triarylcarbonium type basic dye lake pigment (e.g., C.I. Pigment Blue 1, the said 2, the said 9, the said 10, the said 14, the said 62), a triarylcarbonium type acidic dye lake pigment (e.g., C.I. Pigment Blue 18, the said 19, the aid 24:1, the said 24:x, the said 56, the said 61), and an indigo dye (e.g., C.I. Pigment Blue 63, the said 66). Of these, an indanthrone pigment, a triarylcarbonium type basic dye lake pigment, a triarylcarbonium type acidic dye lake pigment and indigo dye are preferred in terms of color (or hue), and an indanthrone pigment is more preferred in terms of fastness. Ultramarine blue and cobalt blue of inorganic pigments are also usable as a blue pigment. Of indanthrone pigments, one which is miscible with an organic solvent is specifically preferred and commercially available, such as Blue A3R-KP (trade name) and Blue A3R-K (trade name), produced by Ciba Speciality Chemicals Corp.

In the embodiments of the invention, it is preferred to use a red or violet pigment in combination with the foregoing blue pigments. Examples of a red pigment include an azo pigment (e.g., C.I. Pigment Red 2, the said 3, the said 5, the said 12, the said 23, the said 48:2, the said 48:3, the said 52:1, the said 53:1, the said 57:1, the said 63:2, the said 112, the said 144, the said 146, the said 150, the said 151, the said 166, the said 175, the said 176, the said 184, the said 187, the said 220, the said 221, the said 245), a quinacridone pigment (e.g., C.I. Pigment Red 122, the said 192, the said 202, the said 206, the said 207, the said 209), a diketopyrrolopyrrole pigment (e.g., C.I. Pigment Red 254, the said 255, the said 264, the said 272), a perylene pigment (e.g., C.I. Pigment Red 123, the said 149, the said 178, the said 179, the said 190, the said 224), a perynone pigment (e.g., C.I. Pigment Red 194), an anthraquinone pigment (e.g., C.I. Pigment Red 83:1, the said 89, the said 168, the said 177), a benzimidazolone pigment (e.g., C.I. Pigment Red 171, the said 175, the said 176, the said 185, the said 2089, a triarylcarbonium type basic dye lake pigment (e.g., C.I. Pigment Red 81:1, the sid 169), a thioindigo pigment (e.g., C.I. Pigment Red 88, the said 181), a pyranthron pigment (e.g., C.I. Pigment Red 216, the said 226), a pyrzoloquinazolone pigment (e.g., C.I. Pigment Red 251, the said 252), and an isoindoline pigment (e.g., C.I. Pigment Red 260). Of the foregoing pigments, an azo pigment, quinacridone pigment, diketopyrrolopyrrole pigment and perylene pigment are preferred, and an azo pigment and a diketopyrrolopyrrole pigment are specifically preferred.

Examples of a preferred violet pigment include an azo pigment (e.g., C.I. Pigment Violet 13, the said 25, the said 44, the said 50), a dioxazine pigment (e.g., C.I. Pigment Violet 23, the said 37), a quinacridone pigment (e.g. C.I. Pigment Violet 19, the said 42), a triarylcarbinium type basic dye lake pigment (e.g., C.I. Pigment Violet 1, the said 2, the said 3, the said 27, the said 39), an anthraquinone pigment (e.g., C.I. Pigment Violet 5:1, the said 33), a perylene pigment (e.g., C.I. Pigment Violet 29), an isoviolanthrone pigment (e.g., C.I. Pigment Violet 31), and a benzimidazolone pigment (e.g., C.I. Pigment Violet 32). Of these violet pigments, an azo pigment, a dioxazine pigment and a quinacridone pigments are preferred, and a dioxazine pigment is specifically preferred. Specifically, dioxazine pigments which are miscible with an organic solvent are preferred and commercially available, for example, Violet B-K (trade name) and Violet B-KP (trade name), produced by Ciba Speciality Chemicals Corp.

In combination with the foregoing pigments, other pigments may be used for adjustment of color (e.g., pigments classified as C.I. Pigment Yellow, C.I. Pigment Orange, C.I. Pigment Brown, C.I. Pigment green). Specific examples of such a compound are described in “Color Index” (The Society of Dyers and Colourists) and W. Herbst, K. H. Hunger, “industrial Organic Pigments” (VCH Verlagsgesellschft mbH, published in 1993).

The pigment usable in the invention may be one as described above or one which has been subjected to a surface treatment. Examples of a surface treatment include a surface coat of resin or wax, adhesion of a surfactant, bonding reactive material (e.g., silane coupling agents, epoxy compounds, polyisocyanates) onto the pigment surface and the use of pigment derivatives (synergist), which are described in “Kinzokusekken no seishitsu to Oyo” (Property and Application of Metallic Soap)” Saiyai-shobo; “Insatsu Ink Gijutsu” (Technology of Printing Ink) CMCI Shuppan (1984) and “Saishin Ganryo Oyo Gijutsu” (Recent Applied Technology of Pigment) CMCI Shuppan (1986). Specifically, commercially available, easily dispersible pigments which have been surface-coated with resin or wax, so-called instant pigments (e.g., Microlith pigment, produced by Ciba Speciality Chemicals Corp.), which can be incorporated into photographic material, without being dispersed and are also readily dispersible in a high boiling solvent, are preferred. In that case, a pigment-dispersed high boiling solvent can also be dispersed in a hydrophilic colloid, such as gelatin.

Although a pigment is dispersed in a high boiling solvent and further dispersed in a hydrophilic colloid such as gelatin, the pigment may be directly dispersed in a hydrophilic colloid. In that case, various types of surfactants, such as a surfactant type low-molecular dispersant or high-molecular dispersant are usable in accordance with a binder used and the pigment, but a high-molecular dispersant is preferred in terms of dispersion stability. Examples of a dispersant include those described in JP-A No. 3-69949 and European Patent No. 549486. The size of dispersed pigment particles is preferably within the range of 0.01 to 10 μm, more preferably 0.02 to 1 μm. Commonly known dispersion techniques employed in manufacture of ink or toner are applicable to dispersion of a pigment in a binder. Examples of a dispersing machine include a sand mill, an atreiter, a pearl mill, a super-mill, a ball mill, an impeller, a three-roll mill and a compression kneader. Details thereof are described in “Saishin Ganryo Oyo Gijutsu”, as cited above.

The foregoing pigments are usable preferably in amount of from 0.1 to 10 mg/m², and more preferably from 0.3 to 5 mg/m². The combined use of a blue pigment and a different color pigment is preferred. Incorporation of a pigment into a hydrophilic colloid layer forming a photographic component layer, which greatly reduces the pigment amount necessary for adjustment to a given tinting level, compared to incorporation of a pigment into polyolefin resin of the support, is preferable in terms of cost. When the foregoing blue pigment is used in combination with the foregoing red pigment and/or violet pigment, these pigments may be dispersed in the same hydrophilic layer or in a different layer.

It is preferred to incorporate an oil-soluble dye into a photographic component layer of the photographic material for the purpose of adjustment of the white-background. Specific examples of such an oil-soluble dye include compounds 1 to 27, described in JP-A No. 2-842, pages (8) and (9).

There may be incorporated a fluorescent brightener into a hydrophilic colloid layer of the photographic material, in which the brightener remaining in the processed photographic material can adjust the white-background. There may also incorporated a polymer such as polyvinyl pyrrolidone, capable of capturing a brightener.

There may be used a thickener to enhance coatability in coating of photographic material using a silver halide emulsion. Useful coating methods include, for example, extrusion coating or curtain coating whereby two or more layers can simultaneously be coated.

To form a photographic image using a photographic material of the invention, an image recorded on a negative film may be printed onto the photographic material through optical imaging. Alternatively, after converting an image to digital information, the image is formed on a CRT (cathode ray tube) and the formed image may be printed on the photographic material through optical imaging. Printing may be conducted by performing scanning, while varying the intensity of a laser light based on the image information.

It is preferred to apply the invention to a photographic material occluding no developing agent, specifically to apply a photographic material forming appreciative images. Examples thereof include color print paper, color reversal paper, positive image-forming photographic material, photographic materials used for displays and photographic materials used for color proofing. Application to a photographic material having a reflective support is specifically preferred.

The photographic material of the invention is used not only in a print system employing a conventional negative printer but is also suitable for a scanning exposure system employing a cathode ray tube (CRT). A cathode ray tube exposure apparatus is simple, compact and low in cost compared to an apparatus employing a laser light. It is also easier to conduct adjustment of an optical axis and color. A cathode ray tube used for imagewise exposure employs various luminous bodies exhibiting emission in the desired spectral region. For example, any one or at least two of a red-emitting body, a green-emitting body and a blue-emitting body are used in combination. The spectral region is not limited to the foregoing red, green and blue, but a fluorescent substance emitting in the yellow, orange, violet or infrared region. There is often used a cathode ray tube which combines the foregoing luminous bodies to emit white light.

When a photographic material has plural light-sensitive layers exhibiting different spectral sensitivity distributions and a cathode ray tube has phosphors emitting different spectral regions, plural colors are exposed at the same time, that is, image signals of plural colors are inputted to a cathode ray tube to be emitted from the tube surface. Alternatively, image signals of the respective colors are successively inputted to perform emissions of the respective colors and exposure is carried out through film cutting out colors other than the intended color (frame sequential exposure). In general, the frame sequential exposure is preferred, which uses a high resolution cathode ray tube, resulting in high quality images.

Preferably, there are used a digital scanning exposure system using monochromatic, high density light, such as a gas laser, a light emission diode, a semiconductor laser or a second harmonic emission light source (SHG) combining a semiconductor laser or a solid laser employing a semiconductor laser as an exciting light with a non-linear optical crystal in the stage of exposing the photographic material to light. To render the system compact and low in price, it is preferred to use a semiconductor laser or a second harmonic emission light source (SHG) by combining a semiconductor laser or a solid laser employing a semiconductor laser as an exciting light with a non-linear optical crystal. To design such a compact, low-priced apparatus having long lifetime and high stability, the use of a semiconductor laser is preferred and it is further preferred to use a semiconductor laser as at least one of exposure light sources.

When using a light source for the scanning exposure, the wavelength at the spectral sensitivity maximum of the photographic material of the invention can be arbitrarily set in accordance with the wavelengths of the light source used for scanning exposure. An SHG light source obtained by the combination of a solid laser employing a semiconductor laser as an exciting light source or a semiconductor with a non-linear optical crystal can reduce a laser oscillation wavelength to a half, whereby blue light and green light are obtained. Accordingly, the photographic material can have a spectral sensitivity maximum in each of the three wavelength regions of blue, green and red. The exposure time in scanning exposure is defined as the time necessary to expose a picture element size at a picture element density of 400 dpi. The exposure time is preferably not more than 10⁻⁴ sec. and not less than 10⁻⁶ sec. The designation “dpi” represents the number of dots per inch or 2.54 cm.

The silver halide color photographic material of the invention is used preferably in combination with exposure and development systems described in known documents. Examples of such a system include an automatic print and development system described in JP-A 10-333253, a photographic material transport apparatus described in JP-A No. 2000-10206, an image read-out apparatus described in JP-A No. 11-215312, an exposure system comprising a color image recording system described in JP-A Nos. 11-88619 and 10-02950, and a digital photo-print system including a remote control diagnostic system described in JP-A No. 10-210206.

The photographic material of the invention preferably satisfies at least one of the following equations (IV), (V) and (VI):
DY(0.5)−DY(10⁻⁶)≦0.2 (IV)
DM(0.5)−DM(10⁻⁶)≦0.2 (V)
DC(0.5)−DC(10⁻⁶)≦0.2 (VI)
wherein DY(0.5), DM(0.5) and DC(0.5) are yellow, magenta and cyan densities, respectively, obtained when the photographic material is subjected to exposure for 0.5 sec. and then to color processing, and DY(10⁻⁶), DM(10⁻⁶) and DC(10⁻⁶) are yellow, magenta and cyan densities, respectively, obtained when the photographic material is subjected to exposure for 10⁻⁶ sec. and then to color processing, provided that DY, DM and DC represent yellow, magenta and cyan densities, respectively, obtained at an exposure amount greater than an exposure amount giving a density of 0.7, by 0.5LogE.

Thus, at least one of the value of DY(0.5)−DY(10⁻⁶) of the yellow image forming layer, the value of DM(0.5)−DM(10⁻⁶) of the magenta image forming layer and the value of DC(0.5)−DC(10⁻⁶) of the cyan image forming layer is preferably not more than 0.1, more preferably not more than 0.15, and still more preferably not more than 0.1.

When the gradation of the yellow image obtained at an exposure of 0.5 sec. and that of the yellow image obtained at an exposure of 10⁻⁶ sec. are superposed at the point of a reflection density of 0.7, the value of DY(0.5)−DY(10⁻⁶) means the difference of the reflection image density obtained at an exposure of 10⁻⁶ sec. and an exposure amount greater than the superposing point by of 0.5LogE from that obtained at an exposure of 0.5 sec. and an exposure amount greater than the superimposing point by 0.5LogE. The value of DY(0.5)−DY(10⁻⁶) is the closer to 0, reciprocity law failure in intensity of the yellow image forming layer is lessened. The foregoing method is also applicable to the magenta and cyan image forming layers.

A silver halide color photographic material is processed according to the following processing steps. Thus, the exposed photographic material is developed in a color development step (color developer solution), and then further processed via a bleaching step (bleaching solution) and fixing step, or a bleach-fixing step (bleach-fixer solution), and a stabilizing step (stabilizer solution) and dried. The photographic material can be continuously processed, while replenishing a color developer replenishing solution, a fixer replenishing solution, a bleach replenishing solution (or a bleach-fixer replenishing solution) and a stabilizer replenishing solution. There will be described below a color developer solution, a bleach solution, a bleach-fixer solution, a fixer solution, a stabilizer solution and a rinse solution.

Color developing agents usable in the invention are preferably a primary amine developing agents, and more preferably p-phenylenediamine derivatives. Representative examples thereof are shown below but are not limited to these examples:
1) N,N-diethyl-p-phenylendiamine,
2) 4-amino-3-methyl-N,N-diethylaniline,
3) 4-amino-N-(β-hydroxyethyl)-N-methylaniline,
4) 4-amino-N-ethyl-N-(β-hydroxyethyl)-aniline,
5) 4-amino-3-methyl-N-ethyl-N-(β-hydroxyethyl) aniline,
6) 4-amino-3-methyl-N-ethyl-N-(3-hydroxypropyl)aniline,
7) 4-amino-3-methyl-N-ethyl-N-(4-hydroxybutyl)aniline,
8) 4-amino-3-methyl-N-ethyl-N-(β-methanesulfoneamido-ethyl)aniline,
9) 4-amino-N,N-diethyl-3-(β-hydroxyethyl)aniline
10) 4-amino-3-methyl-N-ethyl-N-(β-methoxyethyl) aniline,
11) 4-amino-3-methyl-N-ethyl-N-(β-ethoxyethyl)-N-ethylaniline,
12) 4-amino-3-methyl-N-(3-carbamoylpropyl)-N-n-propylaniline
13) 4-amino-N-(4-carbamoylbutyl)-N-n-propyl-3-methylaniline
14) N-(4-amino-3-methylphenyl)-3-hydroxypyrrolidine
15) N-(4-amino-3-methylphenyl)-3-(hydroxymethyl)pyrrolidine
16) N-(4-amino-3-methylphenyl)-3-pyrrolidinecarboxamide

Of the foregoing p-phenylenediamine derivatives, compounds 5), 6), 7), 8) and 12) are preferred and specifically, compounds 5) and 8) are more preferred. These p-phenylenediamine derivatives may be in the form of a salt such as a sulfate, hydrochloride, sulfite, naphthalenedisulfonate o p-toluenesulfonate or in the form of a free base (also called a free body). The aromatic primary amine developing agent described above is used preferably in an amount of from 2 to 200 mmol per liter of a working developer solution, more preferably from 6 to 100 mmol, and still more preferably from 10 to 40 mmol.

To reduce of disappearance of a developing agent due to oxidation, preservatives are employed in a developer solution. Representative preservatives are hydroxylamine derivatives. Examples of hydroxylamine derivatives include hydroxylamine salts such as hydroxylamine hydrochloride and hydroxylamine derivatives, as described in JP-A Nos. 1-97953, 1-186939, 1-186940 and 1-187557. Specifically, a hydroxylamine derivative represented by the following formula (A) is preferred: 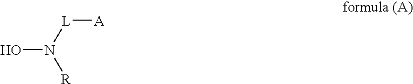
wherein L is an alkylene group which may be substituted; A is a carboxyl group, a sulfo group, a phosphono group, a phosphine group, a hydroxyl group, an amino group which may be substituted by an alkyl group, an ammonio group which may be substituted by an alkyl group, a carbamoyl group which may be substituted by an alkyl group, a sulfamoyl group which may be substituted by an alkyl group, an alkylsulfonyl group, a hydrogen atom, an alkoxyl group, or —O—(B—O)ₙ—R′; R and R′ are each a hydrogen atom or an alkyl group which may be substituted; B is an alkylene group which may be substituted; n is an integer of 1 to 4.

In the formula (A), L is preferably a straight or branched alkylene group having 1 to 10 carbon atoms, which may be substituted by a substituent, and more preferably an alkylene group having 1 to 5 carbon atoms. Specific examples of a preferred alkylene group include methylene, ethylene, trimethylene and propylene groups. Examples of a preferred substituent include a carboxyl group, a sulfo group, a phosphono group, a phosphine group, a hydroxyl group and an ammonio group which may be substituted by an alkyl group, and a carboxyl group, a sulfo group, a phosphine group and a hydroxyl group are preferred. A is a carboxyl group, a sulfo group, a phosphono group, a phosphine group, a hydroxyl group, or an amino, ammonio or carbamoyl or sulfamoyl group, each of which may be substituted by an alkyl group; of these, a carboxy group, a sulfo group, a hydroxyl group, a phosphono group and a carbamoyl group which may be substituted by an alkyl group are preferred examples. Preferred examples of -L-A include carboxy methyl, carboxymethyl, carboxypropyl, sulfoethyl, sulfopropyl, sulfobutyl, phosphonomethyl, phosphonoethyl and hydroxyethyl; and carboxy methyl, carboxymethyl, sulfoethyl, sulfopropyl, phosphonomethyl and phosphonoethyl are specifically preferred. R is preferably a hydrogen atom or a straight or branched alkyl group having 1 to 10 carbon atoms (more preferably 1 to 5 carbon atoms), which may be substituted by a substituent. Examples of such a substituent include a carboxyl group, a sulfo group, a phosphono group, a phosphine group, a hydroxy group, an amino, ammonio, carbamoyl or sulfamoyl group, each of which may be substituted by an alkyl group, an alkoxyl group and —O—(B—O)ₙ—R′. The foregoing B and R′ are the same as defined in the foregoing A. The substituent may be one or more. Preferred examples of R include hydrogen atom, carboxy methyl, carboxymethyl, carboxypropyl, sulfoethyl, sulfopropyl, sulfobutyl, phosphonomethyl, phosphonoethyl, and hydroxyethyl; and of these, hydrogen atom, carboxy methyl, carboxymethyl, sulfoethyl, sulfopropyl, phosphonomethyl and phosphonoethyl are specifically preferred. L and R may combine with each other to form a ring.

Specific examples of a compound of formula (A) are shown below but are not limited to these.

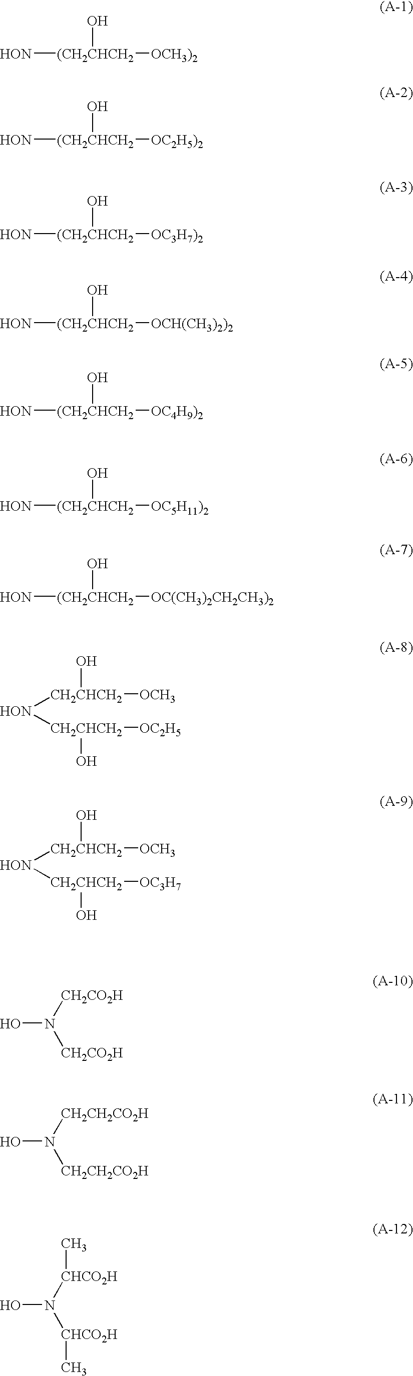

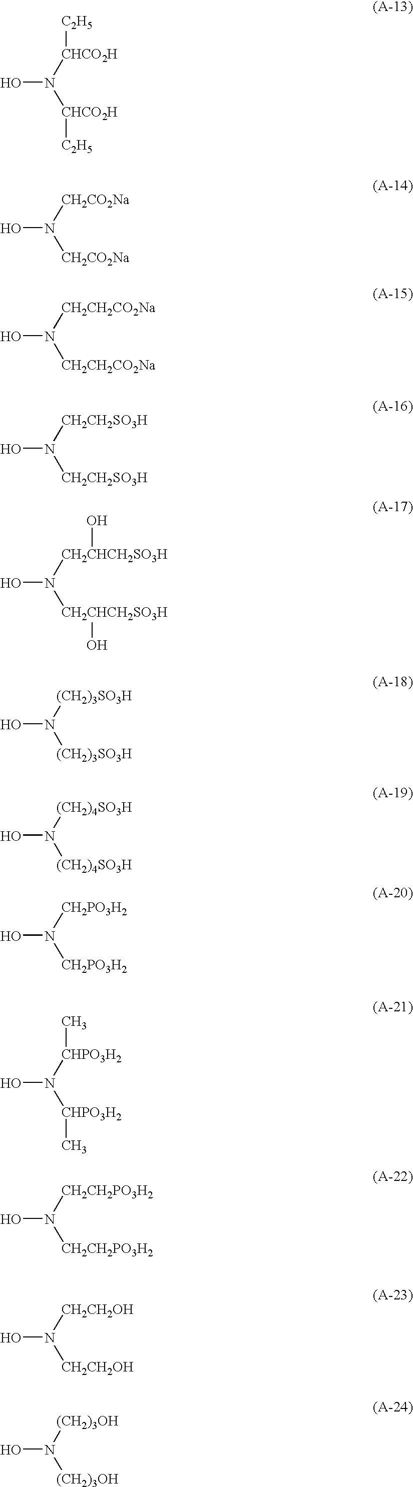

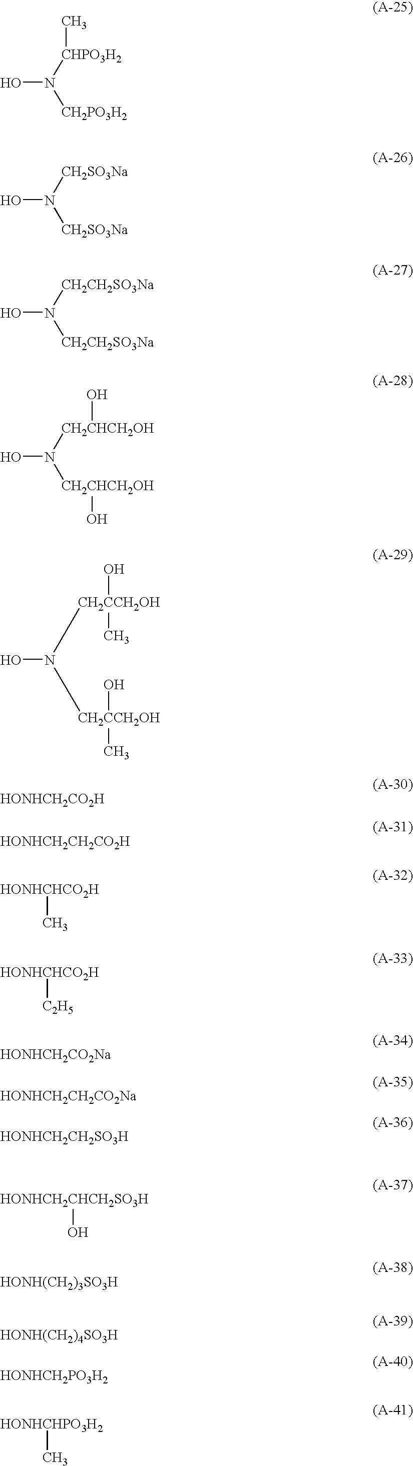

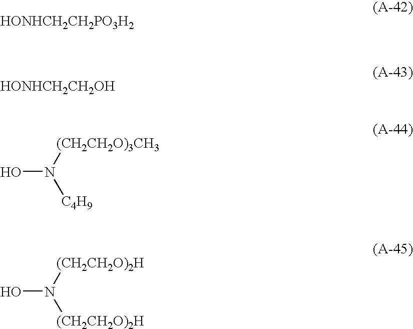

Sulfites are also preferably used as a preservative, and its concentration is preferably from 0.005 to 1.0 mol/l for a color developer solution used for color negative and from 0 to 0.1 mol/l for color developer solution used for color paper. Examples of a sulfite usable in embodiments of the invention include sodium sulfite, potassium sulfite and ammonium sulfite.

In addition to the foregoing preservatives, the other preservatives are usable, for example, hydroxamic acids, hydrazides, phenols, α-hydroxyketones, α-aminoketones, saccharides, monoamines, diamines, polyamines, quaternary ammonium salts, nitroxy radicals, alcohols, oximes, diamide compounds and condensed cyclic amines. These compounds are described in JP-A Nos. 63-4235, 63-30845, 63-21647, 63-44655, 63-53551, 63-43140, 63-56654, 63-58346, 63-43138, 63-146041, 63-44657, 63-44656; U.S. Pat. Nos. 3,615,503, 2,494,903; JP-A No. 52-143020; JP-B No. 48-30496 (hereinafter, the term, JP-B refers to Japanese Patent Publication).

Further, there may optionally be contained various kinds of metals described in JP-A Nos. 57-44148 and 57-53749, salicylic acids described in JP-A No. 59-180588, alkanolamines such triethanolamine and triisopropanolamine described in JP-A No. 54-3532, and aromatic polyhydroxy-compounds described in U.S. Pat. No. 3,746,544.

The pH of a color developer solution is preferably from 9.0 to 13.5, and more preferably from 9.5 to 12.0. An alkaline agents, buffers and optionally acids may be contained to maintain the pH value.

In the preparation of a color developer solution, the following buffering agents are used. Thus, examples of buffering agents usable in the invention include a carbonate, phosphate, borate, tetraborate, hydroxybenzoate, glycyl salt, N,N-dimetylglycine salt, leucine salt, norleucine salt, guanine sit, 3,4-dihydroxyphenylalanine salt, alanine salt, aminobutyric acid, 2-amino-2-methyl-1,3-propanediol salt, valine salt, proline salt, trishydroxyaminomethane salt, and lycine salt. Of the foregoing, a carbonate, phosphate, tetraborate, and hydroxybenzoate, which are superior as a buffer in the high pH region of 10.0 or more, are preferred in terms of no adverse effect on photographic performance (e.g., fogging) and low price.

Specific compounds as a buffering agent include, for example, sodium carbonate, potassium carbonate, sodium bicarbonate, potassium bicarbonate, trisodium phosphate, tripotassium phosphate, disodium phosphate, dipotassium phosphate, sodium borate, potassium borate, sodium tetraborate (borax), potassium tetraboarate, sodium o-hydroxybenzoate (sodium salicylate), potassium o-hydroxybenzoate, sodium 5-sulfo-2-hydroxybenzoate (sodium 5-sulfosalicylate), and potassium 5-sulfo-2-hydroxybenzoate (sodium 5-sulfosalicylate), but are not limited to the foregoing compounds. A buffering agent is contained preferably in an amount of from 0.01 to 2 mol per liter of a color developer solution, more preferably from 0.1 to 0.5 mol.

The color developer solution used in the invention may contain other ingredients, such as various kinds of chelating agents, which are usable for preventing precipitation of calcium or magnesium or enhancing stability of color developer solution. Examples of chelating agents include nitrilotriacetic acid, diethylenetriaminepentaacetic acid, ethylenediaminetetraacetic acid, N,N,N-trimethylenephosphonic acid, ethylenediamine-N,N,N′,N′-tetramethylenesulfonic acid, trans-siloxanediaminetetraacetic acid, 1,2-diaminopropanetetraacetic acid, glycol-ether-diaminetetraacetic acid, ethylenediamine-o-hydroxyphenylacetic acid, ethylenediamine-disuccinic acid (SS isomer), N-(2-carboxylateethyl)-L-asparagic acid, β-alaninediacetic acid, 2-phosphonobutane-1,2,4-tricarboxylic acid, 1-hydroxyethylidene-1,1-diphosphonic acid, 1-hydroxyethylidene-1,1-diphosphonic acid, N,N′-bis(2-hydroxybenzyl)ethylenediamine-N,N′-diacetic acid, and 1,2-dihydroxybenzene-4,6-disulfonic acid. These chelating agents may optionally be used in their combination. A chelating agent is used in an amount sufficient for sequestering metal ions contained in color developer solution, for example, 0.1 to 10 g per liter.

The developer solution used in the invention may contain a development accelerator. Examples of a development accelerator usable in the invention include thioether compounds described in JP-B Nos. 37-16088, 37-5987, 38-7826, 44-12380 and 45-9019, and U.S. Pat. No. 3,813,247; p-phenylenediamine type compounds described in JP-A No. 52-49829; quaternary ammonium compounds described in JP-A No. 50-137726, JP-B No. 44-30074 and JP-A Nos. 56-156826 and 52-43429; amine compounds described in U.S. Pat. Nos. 2,494,903, 3,128,182, 4,230,796 and 3,253,919, JP-B No. 41-11431, and U.S. Pat. Nos. 2,482,546, 2,596,926 and 3,582,346; polyalkyleneoxide compounds described in JP-B Nos. 37-16088 and 42-25201, U.S. Pat. No. 3,128,183, JP-B Nos. 41-11431 and 42-23883, and U.S. Pat. No. 3,532,501; 1-phenyl-3-pyrazolidones and imidazoles. These compounds are contained preferably in an amount of from 0.001 to 0.2 mol per liter of color developer solution, and more preferably from 0.01 to 0.05 mol.

In addition to halide ions, any fog inhibitor may be added to the color developer solution. Examples of an organic fog inhibitor include nitrogen-containing heterocyclic compounds such as benzotriazole, 6-nitrobenzimidazole, 5-nitroisoindazole, 5-methylbenzotriazole, 5-nitrobenzotriazole, 2-thiazolyl-benzimidazole, 2-thiazolylmethyl-benzimidazole, indazole, hydroxyazaindolidine, and adenine.

The color developer solution may optionally contain a fluorescent brightener. Bis(triazinylamino)stilbenesulfonic acid compounds are preferred as a brightener. Commonly known or commercially available diaminostilbene type compounds are usable as a bis(triazinylamino)stilbenesulfonic acid compound. Commonly known bis(triazinylamino)stilbenesulfonic acid compounds, for example, compounds described in JP-A Nos. 6-329936, 7-140625 and 10-140849 are preferred. Commercially available compounds are described, for example, in “Senshoku Note” 9th edition (published by Shisen-sha) page 165-168, in which Blankophor BSU liq. and Hakkol BRK are preferred. Other examples of bis(triazinylamino)stilbenesulfonic acid compound include compounds I-1 to I-48 described in paragraph Nos. [0038] to [0049] of JP-A No. 2001-281823 and compounds II-1 to II-16 described in paragraph Nos. [0050] to [0052] of JP-A No. 2001-281823. The foregoing brighteners are contained preferably in an amount of from 0.1 mmol to 0.1 mol per liter of color developer solution.

A color developer solution for use in color paper preferably contains bromide ions at not more than 1.0×10⁻³ mol/l. The color developer solution for use in color paper preferably contains chloride ions at 3.5×10⁻³ to 1.5×10⁻¹ mol/l but since chloride ions are released to a developer solution as a bi-product of development, a replenisher solution may often contain no chloride ion.

The color developing temperature is preferably from 30° to 55° C., more preferably from 35° to 55° C., and still more preferably from 38° to 45° C. when used for color paper as a silver halide color photographic material.

In the image forming method relating to the invention, the silver halide color photographic material is subjected to color development preferably within 0.1 to 30 sec. after subjected to scanning exposure, the color development time is preferably from 5 to 60 sec. more preferably from 5 to 50 sec., and still more preferably from 5 to 30 sec. The low replenishing rate is preferable, and is preferably from 15 to 600 ml per m² of photographic material, more preferably from 15 to 120 ml, and still more preferably from 30 to 60 ml. The color development time refers to the time from when a photographic material is placed into a color developer solution to when the photographic material is placed into the subsequent processing step (for example, bleach-fixing solution). When the photographic material is processed in an automatic processor, the color development time is the sum of the time during which the photographic material is dipped into a color developer solution (so-called solution time) and the time during which the photographic material leaves the color developer solution and is transported to the subsequent processing step (so-called cross-over time). The cross-over time is preferably not more than 10 sec. and more preferably not more than 5 sec.

Any bleaching agent is usable in a bleaching solution or bleach-fixing solution. Specifically, organic complex salts of iron (III), e.g., complex salts of aminopolycarboxylic acids such as ethylenediaminetetraacetic acid, diethylenetriaminepentaacetic acid, nitrilotriacetic acid, cyclohexanediaminetetraacetic acid and ethylenediaminedisuccinic acid, aminopolyphosphonic acids, phosphonocarboxylic acid and organic phosphonic acid; organic acids such as citric acid, tartaric acid and malic acid, persulfate salts and hydrogen peroxide are preferred. Of these, iron (III) complex salts of ethylenediaminetetraacetic acid, diethylenetriaminepentaacetic acid, cyclohexanediaminetetraacetic acid, 1,3-diaminopropanetetraacetic acid, ethylenediaminedisuccinic acid and methyliminodiacetic acid are preferred in terms of high bleaching power. These ferric ion complexes may be used in the form of a complex salt or a ferric ion complex may be formed in a solution by using a ferric salt such as ferric sulfate, ferric chloride, ferric nitrate, ferric sulfate ammonium or ferric phosphate, and a chelating agent such as an aminopolycarboxylic acid, an aminopolyphosphonic acid or phosphonocarboxylic acid. Of iron (III) complexes, an aminopolycarboxylic acid is preferred and its amount is preferably from 0.01 to 1.0 mol/l, and more preferably from 0.05 to 0.50 mol/l.

A bleaching solution or a bleach-fixing solution may contain various compounds as a bleach-accelerating agent. For example, compounds containing a mercapto group or a disulfide bond, as described in Research Disclosure 17129 (July, 1978), thiourea type compounds, and a halide such as iodide or bromide ion are preferred in terms of superior bleaching power.

A bleaching solution or a bleach-fixing solution may further contain a re-halogenating agent such as a bromide (e.g., potassium bromide), a chloride (e.g., potassium chloride) or a iodide (e.g., ammonium iodide). There may optionally be added at least one inorganic or organic acid or its alkali metal or ammonium salt which exhibits pH-buffering capability, such as borax, sodium metaborate, acetic acid, sodium acetate, sodium carbonate, potassium carbonate, citric acid, sodium citrate tartaric acid, succinic acid, maleic acid or glycolic acid; or a corrosion inhibitor such as ammonium nitrate or guanidine.

Fixing agents usable in a fixer solution or bleach-fixer solution include commonly known fixing agents, that is, water-soluble silver halide solvent for example, a thiosulfate such as sodium thiosulfate or ammonium thiosulfate, a thiocyanate such as sodium thiocyanate or ammonium thiocyanate, a thio-ether compound such as ethylenebisthioglycolic acid or 3,6-dithia-1,8-octanediol and thioureas, which are water-soluble silver halide solvents and can be used singly or in their combination. Of these, thiosulfates, specifically, ammonium thiosulfate is preferred. A fixing agent is used preferably in an amount of from 0.1 to 5.0 mol per liter of a fixer solution, and more preferably from 0.3 to 2.0 mol. The pH range of a bleach-fixer or fixer solution is preferably from 3 to 10, and more preferably from 5 to 9.

A bleaching solution, fixer solution or bleach-fixer solution may further contain various kinds of fluorescent brighteners, defoaming agents, surfactants, polyvinyl pyrrolidone or organic solvents such as methanol.

A bleaching solution, fixer solution or bleach-fixer solution usually contain a sulfite as a preservative such as sodium sulfite, potassium sulfite, ammonium sulfite, potassium hydrogensulfite, sodium hydrogensulfite, sodium metabisulfite, potassium metabisulfite or ammonium metabisulfite. Further, there may be added ascorbic acid, carbonyl bisulfite adduct or a carbonyl compound.

Furthermore, there may optionally be incorporated a buffering agent, a fluorescent brightener, a chelating agent, a defoaming agent or an antiseptic agent. The bleaching solution, fixer solution or bleach-fixer solution contains an ammonium cation preferably at a concentration of not more than 50 mol % in terms of workability and preferably at a concentration not less than 50 mol % in terms of processability.

The time for the bleach-fixing step applicable to silver halide color photographic materials relating to the invention is preferably not more than 90 sec., and more preferably not more than 45 sec. The time for the bleach-fixing step refers to the time of from the time when the photographic material is dipped into the first bath to the time when the photographic material comes out of the final bath in cases where this step is comprised of plural baths, and, in the case of a single bath, it is the time until when the photographic material is dipped into the following rinsing or stabilizing solution, in which a cross-over time is included. The cross-over time is preferably not more than 10 sec., and more preferably not more than 5 sec. The bleach-fixing temperature is preferably from 20° to 70° C., and more preferably from 25° to 50° C. The replenishing rate of the bleach-fixer solution is preferably not more than 200 ml/m², and more preferably from 20 to 100 ml/m².

The replenishing rate of a bleaching solution is preferably not more than 200 ml/m², and more preferably from 20 to 200 ml/m². The time for the bleaching step is preferably 15 sec. to 90 sec. in total. The time for the bleaching step refers to the time from when a photographic material is dipped into the first bath to when the photographic material comes out of the final bath in cases where the step is comprised of plural baths, and, in the case of a single bath, it is the time until when the photographic material is dipped into the following rinsing or stabilizing solution, in which a cross-over time is to be included. The cross-over time is preferably not more than 10 sec., and more preferably not more than 5 sec. The bleaching temperature is preferably from 25° to 50° C.

The time for the fixing step is preferably from 15 sec. to 90 sec. in total. The time for the fixing step refers to the time from when the photographic material is dipped into the first bath to when the photographic material comes out of the final bath in cases where the step is comprised of plural baths, and, in the case of a single bath, it is the time until when the photographic material is dipped into the following rinsing or stabilizing solution, in which a cross-over time is to be included. The cross-over time is preferably not more than 10 sec., and more preferably not more than 5 sec. The fixing temperature is preferably from 25° to 50° C.

Next, there will be described processing solution used in the rinsing or stabilizing step. A rinsing or stabilizing solution used in the invention contains constituents included in conventional stabilizing solutions, such as a chelating agent (e.g., ethylenediaminetetraacetic acid, diethylenetriaminepentaacetic acid, 1-hydroxyethylidene-1,1-diphosphonic acid), a buffer (e.g., potassium carbonate, borates, acetates, phosphates), a fungicide (e.g., Dearcide 702, produced by U.S. Dearborn Corp., p-chloro-m-cresol, benzoylisothiazoline-3-one), an antioxidant (e.g., ascorbic acid), and a water soluble metal salt (e.g., zinc salt, magnesium salt).

The rinsing or stabilizing solution may contain an arylsulfinic acid such as p-tolyenesulfinic acid or m-carboxybenzenesulfinic acid in terms of solution storage stability. It is preferred to contain a sulfite, a bisulfite or metabisulfite. Any organic or inorganic material capable of releasing a sulfite is usable but an inorganic salt is preferred. Preferred examples thereof include sodium sulfite, potassium sulfite, ammonium sulfite, ammonium bisulfite, potassium bisulfite, sodium bisulfite, sodium metabisulfite, potassium metabisulfite and ammonium metabisulfite. The foregoing salts are contained preferably in an amount of not less than 1×10⁻³ mol/l, and more preferably from 5×10⁻³ mol/l 5×10⁻² mol/l.

The pH of the stabilizing step is preferably from 4 to 10, and more preferably from 5 to 8. The stabilizing step may be set at any appropriate temperature, depending on the use or characteristics of silver halide color photographic material to be processed but is usually from 15° to 45° C., and preferably from 20° to 40° C. Any appropriate time for the stabilizing step may be set but a shorter time is desirable in terms of reduction of the processing time. The stabilizing time is preferably from 5 sec. to 1 min. 45 sec, and more preferably 10 sec. to 1 min. Specifically in the case of silver halide color photographic material being color print paper, the time needed for the stabilizing step is preferably from 8 to 26 sec. and in the case of negative film, it is preferably from 10 to 40 sec.

A low replenishing rate is more preferred in terms of lowered running cost, reduction of effluent and ease of handling. Specifically, the replenishing rate is preferably from 0.5 to 50 (more preferably from 3 to 40) times the carry-in amount from the preceding bath, per unit area of silver halide color photographic material. It is also preferably not more than 1 liter per m² of silver halide color photographic material, and more preferably not more than 500 ml. Replenishment may be carried out continuously or intermittently.

In the processing method relating to the invention, a stabilizing step using a stabilizing solution may be constituted of a single bath, or two or more baths and a cascaded countercurrent system which is constituted of at least two baths is preferred. The cascaded countercurrent system refers to a system in which, in the stabilizing bath divided into plural baths, stabilizing solution flows upstream of the transport direction of photographic material, while over-flowing into the respective divided baths along the transport route of the photographic material to perform stabilization.

As a processing apparatus used in the invention is applicable a roller transport type processor in which the photographic material is transported by being nipped by rollers and an endless belt type processor in which the photographic material is transported, while being fixed to a belt. Further thereto are also employed a method in which a processing solution supplied to a slit-formed processing bath and a photographic material is transported therethrough, a spraying method, a web processing method employing contact with a carrier impregnated with a processing solution and a method using viscous processing solution. A large amount of photographic materials is conventionally processed using an automatic processor. In such a case, a lower replenishing rate is preferred and an environmentally friendly processing embodiment is replenishment made in the form of a solid tablet, as described in KOKAI-GIHO (Disclosure of Techniques) 94-16935.

Photographic material used for print, relating to the invention exhibits markedly improved image quality when exposed through negative film having an area of 3 to 7 cm² per picture plane to form images. The negative film may be one having information recording ability.

### EXAMPLES

The present invention will be further described based on examples but are by no means limited to these examples.

### Example 1

### Blue-Sensitive Silver Halide Emulsion

Preparation of Silver Halide Emulsion

Using a silver chloride emulsion of an average grain size of 0.141 μm as seed crystal grains, silver halide emulsion A-1 was prepared employing a mixing stirrer apparatus described in JP-A No. 62-160128 to perform grain growth according to the following procedure. In 4.1 lit. of pure water were dissolved 102.5 g of deionized gelatin, and 10.5 g of NaCl and 2.5 ml of 10 wt % methanol solution of the following surfactant V was added thereto and seed crystal grains equivalent to 0.133 mol in terms of the equivalent quantity of silver nitrate were added, while maintaining at 45° C. Immediately after adjusting the EAg to 123 mV with an aqueous 2.2 mol/l NaCl solution with stirring at a high-speed, an aqueous AgNO₃ solution S1 and an aqueous halide (NaCl and KBr) solution X1, as shown in Table 1, were added by the double jet addition over 107 min. (first addition).
Surfactant V: HO(CH₂CH₂O)ₘ[CH(CH₃) CH₂O]₂₀(CH₂CH₂O)ₙH (M+n=10)

Subsequent to the addition of solutions S1 and X1, an aqueous AgNO₃ solution S2 and an aqueous halide (NaCl and KBr) solution X2, as shown in Table 1, were added by the double jet addition over 19 min. (second addition). After completion of the foregoing addition, an aqueous solution containing 150 g of chemically modified gelatin (modification rate of 95%) of which amino group was phenylcarbamoylated, and desalting and washing were conducted with adjusting the pH, thereafter, additional deionized gelatin was added and dispersed, and the pH and page were each adjusted to 5.7 and 7.6 at 40° C., respectively. There was obtained silver halide emulsion A-1 comprising cubic silver halide grains having a halide composition of 98.3 mol % chloride and 1.7 mol % bromide, an average grain size (cubic equivalent edge length) of 0.72 μm and a coefficient of variation of grain size of 8%.

Silver halide emulsions B-1 to G-1 were prepared similarly to the foregoing silver halide emulsion A-1, provided that the amount of seed crystal grain emulsion and the amounts of solutions used in the first and second additions were varied as shown in Table 1 and the addition time was optimally adjusted for the respective emulsions. Each of the obtained emulsions was comprised of cubic silver halide grains having a coefficient of variation of grain size of 8%.

TABLE 1

| | |
|---|---|
| | Compound Y |
| 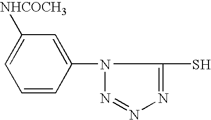 | |

| | | | Silver Halide Emulsion | | | | | | |
|---|---|---|---|---|---|---|---|---|---|
| | | | A-1 | B-1 | C-1 | D-1 | E-1 | F-1 | G-1 |
| Average grain Size (μm) | | | 0.72 | 0.63 | 0.56 | 0.63 | 0.56 | 0.50 | 0.45 |
| Seed | Amount (mol) | | 0.133 | 0.198 | 0.282 | 0.198 | 0.282 | 0.396 | 0.540 |
| Grain | | | | | | | | | |
| First | Solution | Concentration (mol/l) | 3.5 | 3.5 | 3.5 | 3.5 | 3.5 | 3.5 | 3.5 |
| Addi- | S1 (AgNO₃) | Addition Amount (mol) | 12.23 | 12.16 | 12.08 | 12.16 | 12.08 | 11.97 | 11.82 |
| tion | Solution | Concentration*² (mol/l) | 3.5 | 3.5 | 3.5 | 3.5 | 3.5 | 3.5 | 3.5 |
| | X1*¹ | Br Content (mol %) | 0.3 | 0.3 | 0.3 | 0.3 | 0.3 | 0.3 | 0.3 |
| | | K₃IrCl₆*³ | 5.61 × 10⁻⁹ | 8.38 × 10⁻⁹ | 1.19 × 10⁻⁸ | 3.78 × 10⁻⁹ | 5.39 × 10⁻⁹ | 7.57 × 10⁻⁹ | 1.04 × 10⁻⁸ |
| | | K₃IrBr₆*³ | 3.98 × 10⁻⁹ | 5.95 × 10⁻⁹ | 8.47 × 10⁻⁹ | — | — | — | — |
| | | K₃IrCl₅(H₂O)*³ | — | — | — | 2.64 × 10⁻⁷ | 3.75 × 10⁻⁷ | 5.27 × 10⁻⁷ | 7.23 × 10⁻⁷ |
| | | K₄Fe(CN)₆*³ | 2.22 × 10⁻⁶ | 3.31 × 10⁻⁶ | 4.71 × 10⁻⁶ | 3.31 × 10⁻⁶ | 4.71 × 10⁻⁶ | 6.62 × 10⁻⁶ | 9.07 × 10⁻⁶ |
| | | Compound Y*³ | 8.50 × 10⁻⁷ | 8.50 × 10⁻⁷ | 8.50 × 10⁻⁷ | 8.50 × 10⁻⁷ | 8.50 × 10⁻⁷ | 8.50 × 10⁻⁷ | 8.50 × 10⁻⁷ |
| | | 1% H₂SO₄ (ml) | 1.0 | 1.0 | 1.0 | 1.0 | 1.0 | 1.0 | 1.0 |
| Second | Solution | Concentration (mol/l) | 3.5 | 3.5 | 3.5 | 3.5 | 3.5 | 3.5 | 3.5 |
| Addi- | S2 (AgNO₃) | Addition Amount (mol) | 5.30 | 5.30 | 5.30 | 5.30 | 5.30 | 5.30 | 5.30 |
| tion | Solution | Concentration*² | 3.5 | 3.5 | 3.5 | 3.5 | 3.5 | 3.5 | 3.5 |
| | X2*¹ | Br Content (mol %) | 5.00 | 5.00 | 5.00 | 5.00 | 5.00 | 5.00 | 5.00 |
| | | Compound Y*³ | 2.12 × 10⁻⁷ | 2.12 × 10⁻⁷ | 2.12 × 10⁻⁷ | 2.12 × 10⁻⁷ | 2.12 × 10⁻⁷ | 2.12 × 10⁻⁷ | 2.12 × 10⁻⁷ |

*¹aqueous solution of NaCl and KBr
*²the total halide concentration (mol/l)
*³mol per mol of total Ag

Preparation of Blue-Sensitive Emulsion A-11

The foregoing silver halide emulsion A-1 was maintained at 65° C., then, 2.30×10⁻³ mol/mol Ag of potassium chloride and 4.0×10⁻⁴ mol/mol Ag of spectral-sensitizing dye A (mixture composed of sensitizing dyes 1 and 2 in a molar ratio of 90:10) were added thereto to perform spectral sensitization and further thereto, 1.51×10⁻² mol/mol Ag of sodium chloride, 1.13×10⁻⁵ mol/mol Ag of p-toluenesulfonic acid, 2.07×10⁻⁶ mol/mol Ag of sodium thiosulfate, 4.97×10⁻⁶ mol/mol Ag of chloroauric acid and 8.36×10⁻⁵ mol/mol Ag of potassium thiocyanate were each added in the form of solution and ripened to perform optimal chemical sensitization. Thereafter, 4.10×10⁻⁵ mol/mol Ag of thiosulfonic acid compound-1, 2.60×10⁻⁴ mol/mol Ag of mercapto compound-1 and 3.31×10⁻⁵ mol/mol Ag of mercapto compound-2 were added and ripened for 10 min. to perform stabilization, thereafter, the emulsion was cooled to obtain blue-sensitive silver halide emulsion A-11. 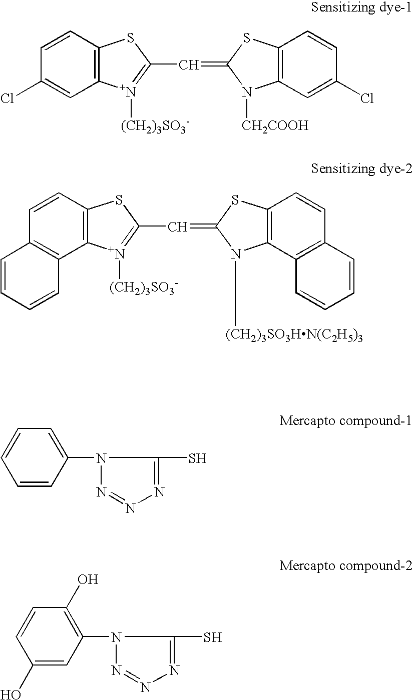
Preparation of Blue-Sensitive Emulsion B-11

Blue-sensitive silver halide emulsion B-11 was prepared similarly to the foregoing blue-sensitive silver halide emulsion A-11, provided that silver halide emulsion A-1 was replaced by silver halide emulsion B-1 and spectral sensitization and chemical sensitization were similarly performed. The addition amounts of the respective additives were optimally adjusted so as to be proportional to the reciprocal of the average grain size, based on silver halide emulsion A-1.

Preparation of Blue-Sensitive Emulsion B-12

Blue-sensitive silver halide emulsion B-12 was prepared similarly to the foregoing blue-sensitive silver halide emulsion B-11, provided that 40 mol % of the added sodium thiosulfate was replaced by chalcogen compound-1 (trifurylphosphine selenide).

Preparation of Blue-Sensitive Emulsion B-13

Blue-sensitive silver halide emulsion B-13 was prepared similarly to the foregoing blue-sensitive silver halide emulsion B-11, provided that the amount of sensitizing dye A was varied as shown in Table 2.

Preparation of Blue-Sensitive Emulsion C-11

Blue-sensitive silver halide emulsion C-11 was prepared similarly to the foregoing blue-sensitive silver halide emulsion A-11, provided that silver halide emulsion A-1 was replaced by silver halide emulsion C-1. The addition amounts of the respective additives were optimally adjusted so as to be proportional to the reciprocal of the average grain size, based on silver halide emulsion A-1.

Preparation of Blue-Sensitive Emulsion C-12

Blue-sensitive silver halide emulsion C-12 was prepared similarly to the foregoing blue-sensitive silver halide emulsion C-11, provided that 40 mol % of the added sodium thiosulfate was replaced by chalcogen compound-1.

Preparation of Blue-Sensitive Emulsion C-13

Blue-sensitive silver halide emulsion C-13 was prepared similarly to the foregoing blue-sensitive silver halide emulsion C-11, provided that the amount of sensitizing dye A was varied as shown in Table 2.

Preparation of Blue-Sensitive Emulsion D-11

Blue-sensitive silver halide emulsion D-11 was prepared similarly to the foregoing blue-sensitive silver halide emulsion B-12, provided that silver halide emulsion B-1 was replaced by silver halide emulsion D-1 and spectral sensitization and chemical sensitization were similarly performed. The addition amounts of the respective additives were optimally adjusted so as to be proportional to the reciprocal of the average grain size, based on silver halide emulsion B-1.

Preparation of Blue-Sensitive Emulsion D-12

Blue-sensitive silver halide emulsion D-12 was prepared similarly to the foregoing blue-sensitive silver halide emulsion D-11, provided that the amount of sensitizing dye A was varied as shown in Table 2.

Preparation of Blue-Sensitive Emulsion E-11

Blue-sensitive silver halide emulsion E-11 was prepared similarly to the foregoing blue-sensitive silver halide emulsion B-12, provided that silver halide emulsion B-1 was replaced by silver halide emulsion E-1 and spectral sensitization and chemical sensitization were similarly performed. The addition amounts of the respective additives were optimally adjusted so as to be proportional to the reciprocal of the average grain size, based on silver halide emulsion B-1.

Preparation of Blue-Sensitive Emulsions E-12 and E-13

Blue-sensitive silver halide emulsions E-12 and E-13 prepared similarly to the foregoing blue-sensitive silver halide emulsion B-11, provided that the amount of sensitizing dye A was varied as shown in Table 2.

Preparation of Blue-Sensitive Emulsion E-14

Blue-sensitive silver halide emulsion E-14 was prepared similarly to the foregoing blue-sensitive silver halide emulsion B-12, provided that the amount of sensitizing dye A was varied as shown in Table 2.

Preparation of Blue-Sensitive Emulsion F-11

Blue-sensitive silver halide emulsion F-11 was prepared similarly to the foregoing blue-sensitive silver halide emulsion B-11, provided that silver halide emulsion B-1 was replaced by silver halide emulsion F-1 and spectral sensitization and chemical sensitization were similarly performed. The addition amounts of the respective additives were optimally adjusted so as to be proportional to the reciprocal of the average grain size, based on silver halide emulsion B-1, provided that sensitizing dye A was added in an amount as shown in Table 2.

Preparation of Blue-Sensitive Emulsion F-12

Blue-sensitive silver halide emulsion F-12 was prepared similarly to the foregoing blue-sensitive silver halide emulsion B-12, provided that silver halide emulsion B-1 was replaced by silver halide emulsion F-1 and spectral sensitization and chemical sensitization were similarly performed. The addition amounts of the respective additives were optimally adjusted so as to be proportional to the reciprocal of the average grain size, based on silver halide emulsion B-1, provided that sensitizing dye A was added in an amount as shown in Table 2.

Preparation of Blue-Sensitive Emulsion G-11

Blue-sensitive silver halide emulsion G-11 was prepared similarly to the foregoing blue-sensitive silver halide emulsion B-12, provided that silver halide emulsion B-1 was replaced by silver halide emulsion G-1 and spectral sensitization and chemical sensitization were similarly performed. The addition amounts of the respective additives were optimally adjusted so as to be proportional to the reciprocal of the average grain size, based on silver halide emulsion B-1, provided that sensitizing dye A was added in an amount as shown in Table 2.

TABLE 2

| | | | | Coefficient of |
|---|---|---|---|---|
| | | | Addition | Addition |
| | Metal | Combined | Amount of | Amount of |
| Blue- | Complex*¹ | Use of | Sensitizing | Sensitizing |
| sensitive | (mol/mol | Chalcogen | Dye (mol/ | dye |
| Emulsion | Ag) | compounds | mol Ag) | (3.2 × 10⁻⁴/LY*²) |
| A-11 | — | — | 4.00 × 10⁻⁴ | 4.44 × 10⁻⁴ |
| B-11 | — | — | 4.57 × 10⁻⁴ | 5.08 × 10⁻⁴ |
| B-12 | — | Yes | 4.57 × 10⁻⁴ | 5.08 × 10⁻⁴ |
| B-13 | — | — | 5.26 × 10⁻⁴ | 5.08 × 10⁻⁴ |
| C-11 | — | — | 5.14 × 10⁻⁴ | 5.71 × 10⁻⁴ |
| C-12 | — | Yes | 5.14 × 10⁻⁴ | 5.71 × 10⁻⁴ |
| C-13 | — | — | 5.91 × 10⁻⁴ | 5.71 × 10⁻⁴ |
| D-11 | 2.64 × 10⁻⁷ | Yes | 4.57 × 10⁻⁴ | 5.08 × 10⁻⁴ |
| D-12 | 2.64 × 10⁻⁷ | — | 5.26 × 10⁻⁴ | 5.08 × 10⁻⁴ |
| E-11 | 3.75 × 10⁻⁷ | Yes | 5.14 × 10⁻⁴ | 5.71 × 10⁻⁴ |
| E-12 | 3.75 × 10⁻⁷ | — | 5.91 × 10⁻⁴ | 5.71 × 10⁻⁴ |
| E-13 | 3.75 × 10⁻⁷ | — | 6.43 × 10⁻⁴ | 5.71 × 10⁻⁴ |
| E-14 | 3.75 × 10⁻⁷ | Yes | 6.43 × 10⁻⁴ | 5.71 × 10⁻⁴ |
| F-11 | 5.27 × 10⁻⁷ | — | 7.20 × 10⁻⁴ | 6.40 × 10⁻⁴ |
| F-12 | 5.27 × 10⁻⁷ | Yes | 7.20 × 10⁻⁴ | 6.40 × 10⁻⁴ |
| G-11 | 7.23 × 10⁻⁷ | Yes | 8.00 × 10⁻⁴ | 7.11 × 10⁻⁴ |

*¹8th group metal complex containing an aqua-ligand or an organic ligand
*²average grain size (LY) of a silver halide emulsion

Green-Sensitive and Red-Sensitive Silver Halide Emulsions

Preparation of Silver Halide Emulsion

Using a silver chloride emulsion of an average grain size of 0.141 μm as seed crystal grains, silver halide emulsion A-1 was prepared employing a mixing stirrer apparatus described in JP-A No. 62-160128 to perform grain growth according to the following procedure. In 4.0 lit. of pure water were dissolved 107 g of deionized gelatin, and 10.5 g of NaCl and 2.5 ml of 10 wt % methanol solution of the following surfactant V was added thereto and seed crystal grains equivalent to 0.314 mol in terms of the equivalent quantity of silver nitrate were added, while maintaining at 45° C. Immediately after adjusting the EAg to 123 mV with an aqueous-2.2 mol/l NaCl solution with stirring at a high-speed, solutions S1 and X1 as shown in Table 3 were added by the double jet addition over 105 min. (first addition).

Subsequent to the addition of solutions S1 and X1, solutions S2 and X2 as shown in Table 3 were added by the double jet addition over 6 min. (second addition). After completion of the foregoing addition, an aqueous solution containing 150 g of chemically modified gelatin (modification rate of 95%) of which amino group was phenylcarbamoylated, and desalting and washing were conducted with adjusting the pH, thereafter, additional deionized gelatin was added and dispersed, and the pH and page were each adjusted to 5.7 and 7.6 at 40° C., respectively. There was obtained silver halide emulsion H-1 comprising cubic silver halide grains having a halide composition of 99.9 mol % chloride and 0.1 mol % bromide, an average grain size (cubic equivalent edge length) of 0.54 μm and a coefficient of variation of grain size of 8%.

Silver halide emulsions I-1 to k-1 were prepared similarly to the foregoing silver halide emulsion H-1, provided that the amount of seed crystal grain emulsion and the amounts of solutions used in the first and second additions were varied as shown in Table 3 and the addition time was optimally adjusted for the respective emulsions. Each of the obtained emulsions was comprised of cubic silver halide grains having a coefficient of variation of grain size of 8%.

TABLE 3

| | | | Silver Halide Emulsion | | | |
|---|---|---|---|---|---|---|
| | | | H-1 | I-1 | J-1 | K-1 |
| Average grain Size (μm) | | | 0.54 | 0.43 | 0.45 | 0.40 |
| Seed | Amount (mol) | | 0.314 | 0.623 | 0.543 | 0.774 |
| Grain | | | | | | |
| First | Solution | Concentration | 3.5 | 3.5 | 3.5 | 3.5 |
| Addition | S1 | (mol/l) | | | | |
| | (AgNO₃) | Adition Amount | 15.58 | 15.27 | 16.23 | 16 |
| | | (mol) | | | | |
| | Solution | Concentration*² | 3.5 | 3.5 | 3.5 | 3.5 |
| | X1*¹ | (mol/l) | | | | |
| | | Br Content | 0.1 | 0.1 | 0.1 | 0.1 |
| | | (mol %) | | | | |
| | | K₃IrCl₆*³ | 1.29 × 10⁻⁸ | 1.87 × 10⁻⁸ | 2.60 × 10⁻⁸ | 1.58 × 10⁻⁸ |
| | | K₃IrBr₆*³ | 1.72 × 10⁻⁸ | 1.79 × 10⁻⁸ | 2.60 × 10⁻⁸ | 5.81 × 10⁻⁸ |
| | | K₃IrCl₅(H₂O)*³ | — | — | — | — |
| | | K₄Fe(CN)₆*³ | 1.31 × 10⁻⁵ | 2.60 × 10⁻⁵ | 2.15 × 10⁻⁵ | 1.70 × 10⁻⁵ |
| | | Compound Y*³ | 8.50 × 10⁻⁷ | 8.50 × 10⁻⁷ | 8.50 × 10⁻⁷ | 8.50 × 10⁻⁷ |
| | | 1% H₂SO₄ (ml) | 1.0 | 1.0 | 1.0 | 1.0 |
| Second | Solution | Concentration | 3.5 | 3.5 | 3.5 | 3.5 |
| Addition | S2 | (mol/l) | | | | |
| | (AgNO₃) | Adition Amount | 1.77 | 1.77 | 0.88 | 0.88 |
| | | (mol) | | | | |
| | Solution | Concentration*² | 3.5 | 3.5 | 3.5 | 3.5 |
| | X2*¹ | Br Content | 0.10 | 0.10 | 4.10 | 4.10 |
| | | (mol %) | | | | |
| | | Compound Y*³ | 2.12 × 10⁻⁷ | 2.12 × 10⁻⁷ | 2.12 × 10⁻⁷ | 2.12 × 10⁻⁷ |

Preparation of Green-Sensitive Emulsion H-11

The foregoing silver halide emulsion H-1 was maintained at 66° C., then, 1.7×10⁻⁴ mol/mol Ag of spectral-sensitizing dye B (mixture composed of sensitizing dyes 3 and 4 in a molar ratio of 99:1) were added thereto to perform spectral sensitization, further thereto, 81 ml of aqueous 5% sulfuric acid, and 1.95×10⁻³ mol/mol Ag of potassium bromide, 1.15×10⁻⁴ mol/mol Ag of p-toluenesulfonic acid, 4.25×10⁻⁷ mol/mol Ag of sulfur compound-1, 1.54×10⁻⁶ mol/mol Ag of sodium thiosulfate, 5.88×10⁻⁶ mol/mol Ag of chloroauric acid and 4.18×10⁻⁴ mol/mol Ag of potassium thiocyanate were each added in the form of solution and ripened to perform optimal chemical sensitization. Thereafter, 9.75×10⁻⁴ mol/mol Ag of potassium bromide and 3.91×10⁻⁴ mol/mol Ag of the foregoing mercapto compound-1 were added and ripened for 10 min. to perform stabilization, thereafter, the emulsion was cooled to obtain green-sensitive silver halide emulsion H-11. 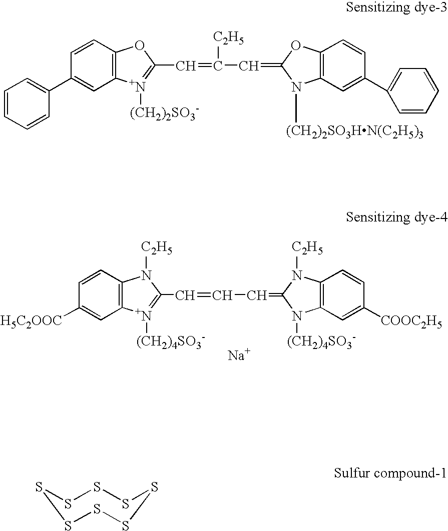
Preparation of Green-Sensitive Emulsion I-11

Green-sensitive silver halide emulsion I-11 was prepared similarly to the foregoing green-sensitive silver halide emulsion H-11, provided that silver halide emulsion H-1 was replaced by silver halide emulsion I-1 and spectral sensitization and chemical sensitization were similarly performed. The addition amounts of the respective additives were optimally adjusted so as to be reversely proportional to the average grain size, based on silver halide emulsion H-1.

Preparation of Red-Sensitive Emulsion J-11

The foregoing silver halide emulsion J-1 was maintained at 65° C., then, 1.04×10⁻³ mol/mol Ag of calcium chloride, 4.61×10⁻⁵ mol/mol Ag of p-toluenesulfonic acid, 3.62×10⁻⁷ mol/mol Ag of the foregoing sulfur compound-1, 1.64×10⁻⁶ mol/mol Ag of sodium thiosulfate, 7.94×10⁻⁶ mol/mol Ag of chloroauric acid and 2.86×10⁻⁴ mol/mol Ag of potassium thiocyanate were added each in the form of solution and ripened to perform optimal chemical sensitization. Then, 3.99×10⁻⁵ mol/mol Ag of sensitizing dye-5 and 2.82×10⁻⁴ mol/mol Ag of spectrally sensitizing aid-1 were added and riped to perform optimum chemical sensitization and spectral sensitization. Thereafter, 3.91×10⁻⁴ mol/mol Ag of the following mercapto compound-3 was added and ripened for 10 min. to perform stabilization, thereafter, the emulsion was cooled to obtain red-sensitive silver halide emulsion J-11. 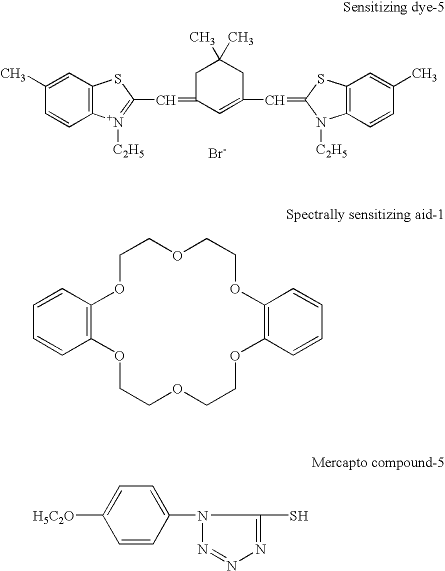
Preparation of Red-Sensitive Emulsion K-11

Red-sensitive silver halide emulsion K-11 was prepared similarly to the foregoing red-sensitive silver halide emulsion J-11, provided that silver halide emulsion J-1 was replaced by silver halide emulsion K-1 and spectral sensitization and chemical sensitization were similarly performed. The addition amounts of the respective additives were optimally adjusted so as to be reversely proportional to the average grain size, based on silver halide emulsion H-1.

### Example 2

### Preparation of Silver Halide Color Photographic Material

Preparation of Sample 201

There was prepared a paper support laminated, on the light-sensitive layer coating side of paper having a weight of 180 g/m², with high density polyethylene, provided that the light-sensitive layer side was laminated with polyethylene melt containing surface-treated anatase type titanium oxide in an amount of 15% by weight. This reflective support was subjected to corona discharge and provided with a gelatin sublayer, and further thereon, the following component layers, as shown below were provided to prepare a silver halide color photographic material sample 201.

As described below, coating solutions were prepared, provided that silver halide emulsions used in the respective light-sensitive layers were as follows:
Emulsion of the 1st layer (blue-sensitive layer):
   Emulsion A-11: Emulsion B-11=90:10,
Emulsion of the 3rd layer (green-sensitive layer):
   Emulsion H-11: Emulsion I-11=5:95,
Emulsion of the 5th layer (red-sensitive layer):
   Emulsion J-11: Emulsion K-11=33:67.

In the preparation of sample 201, there were incorporated additive 1 and hardeners (H-1) and (H-2). Surfactant (SU-2) was used in the preparation of the coupler dispersion of the individual layer, and surfactants (SU-1) and (SU-3) were used as a coating aid to adjust surface tension. Fungicide (F-1) was incorporated to the respective layers at a total amount of 0.04 g/m². The amount of silver halide emulsion was represented by equivalent converted to silver.

Additives used in sample 201 are shown below.

| Layer | Constitution | Amount (g/m²) |
|---|---|---|
| 7th Layer | Gelatin | 0.70 |
| (Protective layer) | Antistaining agent (HQ-1) | 0.003 |
| | Antistaining agent (HQ-2) | 0.02 |
| | High boiling solvent (Sol-1) | 0.01 |
| | Colloidal silica | 0.06 |
| | Matting agent | 0.003 |
| 6th Layer | Gelatin | 0.50 |
| (UV absorbing layer) | UV absorbent (UV-1) | 0.04 |
| | UV absorbent (UV-2) | 0.16 |
| | Antistaining agent (HQ-2) | 0.02 |
| | High boiling solvent (Sol-2) | 0.02 |
| | Blueing agent (WB-1) | 0.0001 |
| | Blueing agent (WB-2) | 0.001 |
| | Image stabilizer (Cpd-1) | 0.006 |
| | Polyvinylpyrrolidone | 0.01 |
| 5th Layer | Gelatin | 1.00 |
| (Red-sensitive layer) | Red-sensitive emulsion (J-11) | 0.053 |
| | Red-sensitive emulsion (K-11) | 0.109 |
| | Cyan coupler (C-1) | 0.20 |
| | Cyan coupler (C-2) | 0.05 |
| | Antistaining agent (HQ-1) | 0.003 |
| | Image stabilizer (Cpd-2) | 0.05 |
| | Image stabilizer (Cpd-3) | 0.01 |
| | High boiling solvent (Sol-1) | 0.17 |
| 4th Layer | Gelatin | 1.10 |
| (UV absorbing layer) | UV absorbent (UV-1) | 0.09 |
| | UV absorbent (UV-2) | 0.35 |
| | Antistaining agent (HQ-2) | 0.05 |
| | High boiling solvent (Sol-2) | 0.06 |
| | Blueing agent (WB-1) | 0.0001 |
| | Blueing agent (WB-2) | 0.001 |
| | Image stabilizer (Cpd-1) | 0.013 |
| 3rd Layer | Gelatin | 1.30 |
| (Green-sensitive layer) | Green-sensitive Emulsion (H-11) | 0.006 |
| | Green-sensitive Emulsion (I-11) | 0.114 |
| | Magenta coupler (M-1) | 0.13 |
| | Image stabilizer (Cpd-4) | 0.18 |
| | UV absorbent (UV-2) | 0.07 |
| | High boiling solvent (Sol-2) | 0.16 |
| 2nd layer | Gelatin | 1.00 |
| (Interlayer) | Antistaining agent (HQ-1) | 0.02 |
| | Antistaining agent (HQ-2) | 0.11 |
| | High boiling solvent (Sol-1) | 0.05 |
| | Brightener (W-1) | 0.07 |
| | Polyvinylpyrrolidone | 0.07 |
| 1st layer | Gelatin | 1.10 |
| (Blue-sensitive layer) | Blue-sensitive Emulsion (A-11) | 0.214 |
| | Blue-sensitive Emulsion (B-11) | 0.024 |
| | Yellow coupler (Y-1) | 0.44 |
| | Antistaining agent (HQ-1) | 0.004 |
| | Image stabilizer (Cpd-1) | 0.006 |
| | Image stabilizer (Cpd-2) | 0.03 |
| | Image stabilizer (Cpd-5) | 0.13 |
| | High boiling solvent (Sol-1) | 0.14 |
| | High boiling solvent (Sol-2) | 0.02 |

Sol-1: tricresyl phosphate
Matting agent: SiO₂ (average particle size: 3.0 μm)
Y-1

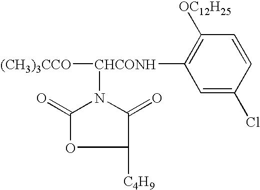

M-1

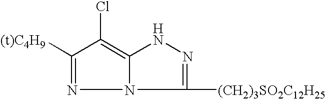

C-1

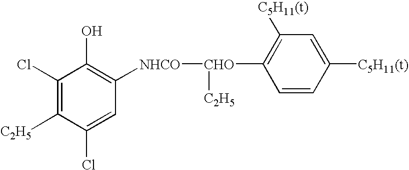

C-2

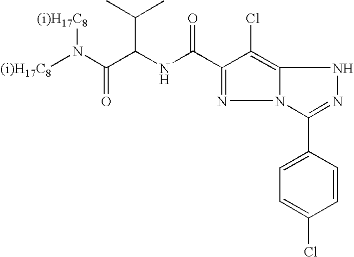

HQ-1

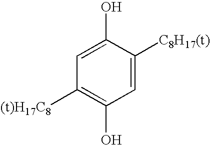

HQ-2

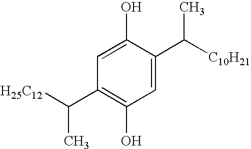

Sol-2

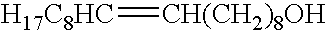

UV-1

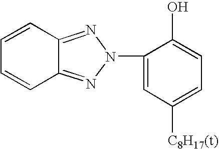

UV-2

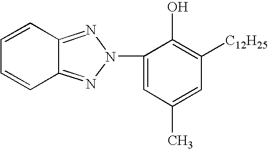

Cpd-1

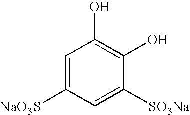

Cpd-2

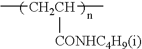

Cpd-3

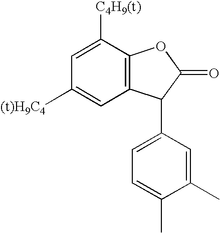

Cpd-4

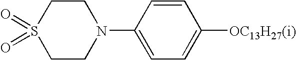

Cpd-5

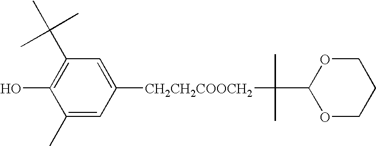

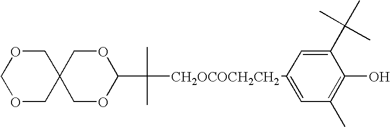

W-1

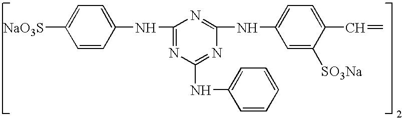

WB-1

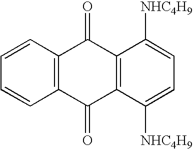

WB-2

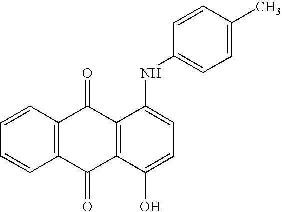

Al-1

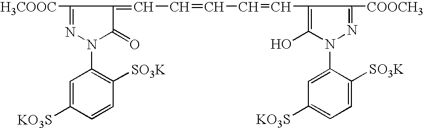

Al-2

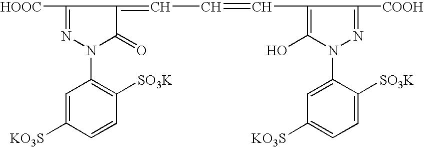

Al-3

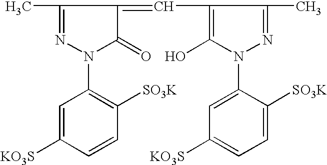

F-1

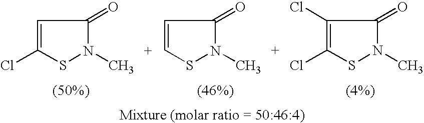

SU-1

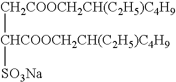

SU-2

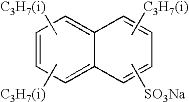

SU-3

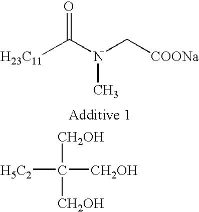

H-1

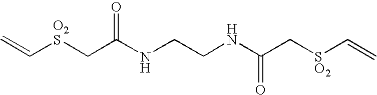

H-2

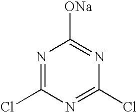

Preparation of Sample 202

Photographic material sample 202 was prepared similarly to the foregoing sample 201, except that blue-sensitive silver halide emulsions A-11 and B-11 used in the 1st layer were replaced by emulsions B-11 and C-11 (i.e., B-11:C-11=90:10).

Preparation of Sample 203

Photographic material sample 203 was prepared similarly to the foregoing sample 202, except that the amounts of blue-sensitive silver halide emulsions B-11 and C-11 were varied so that the total coating weight of silver of the 1st layer was 3.0 g/m² and the ratio of emulsion B-11 to C-11 was the same as in sample 202.

Preparation of Sample 204

Photographic material sample 204 was prepared similarly to the foregoing sample 201, except that blue-sensitive silver halide emulsions A-11 and B-11 used in the 1st layer were replaced by emulsions B-12 and C-12 (i.e., B-12:C-12=90:10).

Preparation of Sample 205

Photographic material sample 205 was prepared similarly to the foregoing sample 201, except that blue-sensitive silver halide emulsions A-11 and B-11 used in the 1st layer were replaced by emulsions B-13 and C-13 (i.e., B-13:C-13=90:10).

### Evaluation of Silver Halide Color Photographic Material

Accelerated Aging of Sample

Two parts were prepared for the foregoing samples 201 to 205 and one of them was subjected to an accelerated aging treatment under natural radiation (which was exposure to radiation equivalent to 300 mR, using Cs¹³⁷ as a radiation source). The thus aged samples were subjected to the following Exposure 1 and Process 1, together with standard samples which were not subjected to the accelerated aging treatment.

Exposure 1

Each sample was cut to a sheet of L-size (89×127 mm) and exposed to light for 0.5 sec. through an optical wedge, using a light source of 5400° K.

Process 1

The thus exposed samples were processed according to the following process 1.

Process 1

| Processsing Step | Temperature | Time | Repl. Amt.* |
|---|---|---|---|
| Color developing | 38.0 ± 0.3° C. | 45 sec. | 80 ml |
| Bleach-fixing | 35.0 ± 0.5° C. | 45 sec. | 120 ml |
| Stabilizing | 30-34° C. | 60 sec. | 150 ml |
| Drying | 60-80° C. | 30 sec. | |

*Replenishing amount

Color Developer (Tank Solution, Replenisher)

| | Tank soln. | Replenisher |
|---|---|---|
| Water | 800 ml | 800 ml |
| Triethylenediamine | 2 g | 3 g |
| Diethylene glycol | 10 g | 10 g |
| Potassium bromide | 0.01 g | — |
| Potassium chloride | 3.5 g | — |
| Potassium sulfite | 0.25 g | 0.5 g |
| N-ethyl-N(β-methanesulfonamidoethyl)- | 6.0 g | 10.0 g |
| 3-methyl-4-aminoaniline sulfate | | |
| N,N-diethylhydroxyamine | 6.8 g | 6.0 g |
| Triethanolamine | 10.0 g | 10.0 g |
| Sodium diethyltriaminepentaacetate | 2.0 g | 2.0 g |
| Brightener (4,4′-diaminostilbene- | 2.0 g | 2.5 g |
| disulfonate derivative) | | |
| Potassium carbonate | 30 g | 30 g |

Water was added to make 1 liter, and the pH of the tank solution and replenisher were respectively adjusted to 10.10 and 10.60 with sulfuric acid or potassium hydroxide.

Bleach-Fixer (Tank Solution, Replenisher)

| | |
|---|---|
| Ammonium ferric diethylenetriamine- | 65 g |
| pentaacetate dihydrate | |
| diethylenetriaminepentaacetic acid | 3 g |
| Ammonium thiosulfate (70% aqueous solution) | 100 ml |
| 2-Amino-5-mercapto-1,3,4-thiadiazole | 2.0 g |
| Ammonium sulfite (40% aqueous solution) | 27.5 ml |
| Water was added to make 1 liter, and the pH was | |
| adjusted to 5.0. | |

Stabilizer (Tank Solution, Replenisher)

| | |
|---|---|
| o-Phenylphenol | 1.0 g |
| 5-Chloro-2-methyl-4-isothiazoline-3-one | 0.02 g |
| 2-Methyl-4-isothiazoline-3-one | 0.02 g |
| Diethylene glycol | 1.0 g |
| Brightener (Chinopal SFP) | 2.0 g |
| 1-Hydroxyethylidene-1,1-diphosphonic acid | 1.8 g |
| Bismuth chloride (40% aqueous solution) | 0.65 g |
| Magnesium sulfate heptahydrate | 0.2 g |
| Polyvinyl pyrrolidine (PVP) | 1.0 g |
| Ammonia water (25% aqueous | 2.5 g |
| arnmonium hydroxide solution) | |
| Trisodium nitrilotriacetate | 1.5 g |

Water was added to make 1 liter, and the pH was adjusted to 7.5 with sulfuric acid or potassium hydroxide.

Densitometry and Evaluation

Using a densitometer PDA-65 (produced by Konica Minolta Photo Imaging, Inc.), the processed samples were measured with respect to reflection densities of the respective steps of a gray step image to prepare a characteristic curve comprised of abscissa of exposure (LogE) and ordinate of reflection density (D).

Evaluation of Radiation Resistance

The unexposed area and the maximum density area of each of the processed samples were measured with respect to reflection density at the wavelength of 450 nm. Then, the value of R(450)=B(450)/[A′(450)−A(450)] was determined as a measure of resistance to radiation, in which A′(450) represents a reflection density of an unexposed area of a sample which has been subjected to accelerated aging treatment under natural radiation, A(450) represents a reflection density of an unexposed area of a standard sample which has not been subjected to accelerated aging treatment under natural radiation, and B(450) represents a reflection density of the maximum density area (Dmax portion). Reduction of an increase of the density of an unexposed area, due to radiation results in a larger value of R(450), which represents superior radiation resistance.

Sensitometry

Sensitivity is represented by a relative value of the reciprocal of an exposure amount necessary to give a yellow reflection density of a density of an unexposed area plus 0.7 in a characteristic curve of a standard sample which has not been subjected to accelerated aging treatment, based on the sensitivity of sample 201 being 100. A larger sensitivity value indicates a higher sensitivity.

The thus obtained results are shown in Table 4.

TABLE 4

| | Radiation | | |
|---|---|---|---|
| | Resistance | | |
| Sample No. | R(450) | Sensitivity | Remark |
| 201 | 55 | 100 | Comp. |
| 202 | 58 | 90 | Comp. |
| 203 | 48 | 101 | Comp. |
| 204 | 64 | 99 | Inv. |
| 205 | 65 | 101 | Inv. |

As apparent from the results shown in Table 4, sample 202 of which the average grain size of the silver halide emulsion used in the blue-sensitive layer was smaller than that of sample 201 (comparative example), resulted in improved radiation resistance but also resulted in reduced sensitivity, making it difficult to achieve high-speed silver halide color photographic material. It was also proved that sample 203 of which the silver content of the blue-sensitive layer was higher than that of sample 202 (comparative example) resulted in enhanced sensitivity but markedly deteriorated radiation resistance, making difficult compatibility of radiation resistance with sensitivity.

On the contrary, it was proved that samples 204 and 205 which used silver halide emulsion meeting the requirements defined in the foregoing equation (I) resulted in improved radiation resistance, while the sensitivity level substantially equivalent to that of comparative example samples, specifically, the total silver content of the blue-sensitive layer of 2.8 g/m² or less achieved superior results.

### Example 3

### Preparation of Silver Halide Color Photographic Material

Preparation of Sample 301

Sample 301 was prepared similarly to the foregoing sample 201 of Example 2, except that silver halide emulsions A-11 and B-11 used in the blue-sensitive layer were replaced by emulsions D-11 and E-11 (i.e., D-11:E-11=90:10).

Preparation of Sample 302

Sample 302 was prepared similarly to the foregoing sample 201 of Example 2, except that silver halide emulsions A-11 and B-11 used in the blue-sensitive layer were replaced by emulsions D-12 and E-12 (i.e., D-12:E-12=90:10).

### Evaluation of Silver Halide Color Photographic Material

Evaluation of Radiation Resistance and Sensitometry

Two samples were prepared for each of the foregoing samples 301 and 302, and sample 201 of Example 2; one of them was subjected to an accelerated aging treatment under natural radiation (which was exposure to radiation equivalent to 300 mR, using Cs¹³⁷ as a radiation source), immediately after preparation of the samples. The thus aged samples were subjected to the foregoing Exposure 1 and Process 1, together with standard samples which were not subjected to the accelerated aging treatment. Evaluation of radiation resistance and sensitometry were conducted according to the method described in Example 2.

Evaluation of Reciprocity Law Failure of Intensity

The samples prepared above and sample 201 of Example 2 were subjected to the following Exposure 2 and Process 2.

Exposure 2

The exposure apparatus was changed to a sensitometer used for xenon flash high intensity exposure (SX-20 Type, produced by Yamashita Denso Co., Ltd.), the exposure amount was optimally adjusted so as to obtain gray step images, in combination with Wratten filters, and exposure was performed through an optical wedge for sensitometry at the exposure time of 10⁻⁶ sec.

Process 2

Process 2 was conducted according to the following process steps:

| Processsing Step | Temperature | Time | Repl. Amt.* |
|---|---|---|---|
| Color developing | 42.0 ± 0.30° C. | 20 sec. | 80 ml |
| Bleach-fixing | 40.0 ± 0.5° C. | 20 sec. | 120 ml |
| Stabilizing | 30-34° C. | 20 sec. | 150 ml |
| Drying | 60-80° C. | 30 sec. | |

*Replenishing amount

Processing solutions used in the respective processing steps were the same as those used in Process 1 described earlier.

Using a densitometer PDA-65 (produced by Konica Minolta Photo Imaging, Inc.), the samples obtained in the foregoing Process 2 were measured with respect to reflection densities of the respective steps of a gray step image to prepare a characteristic curve comprised of abscissa of exposure (LogE) and ordinate of reflection density (D).

Evaluation

From characteristic curve 1 obtained by the combination of the foregoing Exposure 1 (0.5 sec.) and Process 1, reflection density DY(0.5) given by exposure which is more by 0.5LogE than exposure giving a yellow density of 0.7, is determined, and from characteristic curve 2 obtained by the combination of the foregoing Exposure 2 (10⁻⁶ sec.) and Process 2, reflection density DY(10⁻⁶) given by exposure which is more by 0.5LogE than exposure giving a yellow density of 0.7, is determined, from which the value of
S(Y)=DY(0.5)−DY(10⁻⁶)
was determined. The value of S(Y) is the less, the color density can more stably obtained even when the exposure intensity or the development condition is varied.

Obtained results are shown in Table 5.

TABLE 5

| | Radiation | | | |
|---|---|---|---|---|
| Sample | Resistance | | | |
| No. | R(450) | Sensitivity | S(Y) | Remark |
| 201 | 55 | 100 | 0.24 | Comp. |
| 301 | 69 | 104 | 0.11 | Inv. |
| 302 | 71 | 106 | 0.13 | Inv. |

As apparent from the results shown in Table 5, it was proved that sample 301 using a silver halide emulsion which was chemically sensitized with at least two chalcogen compounds and occluding group 8 metal complexes, as blue-sensitive silver halide emulsions of the blue-sensitive layer, exhibited improved radiation resistance and enhanced sensitivity and was stable even when the exposure intensity or the developing condition was varied, compared to comparative example. It was further proved that sample 302 which using a silver halide emulsion which met the foregoing equation (VII) and occluding group 8 metal complexes for a blue-sensitive silver halide emulsion, resulted in superior performance, similarly sample 301.

### Example 4

Preparation of Sample 401

Sample 401 was prepared similarly to the foregoing sample 302 of Example 3, except that silver halide emulsions D-12 and E-12 used in the blue-sensitive layer were replaced by silver halide emulsions E-13 and F-11 (i.e., E-13:F-11=90:10).

Preparation of Sample 402

Sample 402 was prepared similarly to the foregoing sample 302 of Example 3, except that silver halide emulsions D-12 and E-12 used in the blue-sensitive layer were replaced by silver halide emulsions E-13 and F-11 (i.e., E-13:F-11=90:10) and the silver content was varied to 0.21 g/m².

Preparation of Sample 403

Sample 403 was prepared similarly to the foregoing sample 401, except that silver halide emulsions E-13 and F-11 used in the blue-sensitive layer were replaced by silver halide emulsions E-14 and F-12 (i.e., E-14:F-12=90:10) and the silver content was varied to 0.185 g/m².

Preparation of Sample 404

Sample 404 was prepared similarly to the foregoing sample 401, except that silver halide emulsions E-13 and F-11 used in the blue-sensitive layer were replaced by silver halide emulsions F-12 and G-11 (i.e., F-12:G-11=90:10).

Evaluation

The thus prepared samples 401 to 404 and sample 201 of Example 2 were evaluated with respect to radiation resistance and sensitivity similarly to Example 2 and with respect to reciprocity law failure of intensity [denoted as S(Y)] similarly to Example 3. Obtained results are shown in Table 6.

TABLE 6

| | Radiation | | | |
|---|---|---|---|---|
| Sample | Resistance | | | |
| No. | R(450) | Sensitivity | S(Y) | Remark |
| 201 | 55 | 100 | 0.24 | Comp. |
| 401 | 100 | 100 | 0.13 | Inv. |
| 402 | 96 | 102 | 0.13 | Inv. |
| 403 | 105 | 101 | 0.15 | Inv. |
| 404 | 101 | 102 | 0.14 | Inv. |

As apparent from the results of Table 6, it was proved that samples 401 and 402 using silver halide emulsions which satisfied the equation (VII′), and occluding a group 8 metal complex and having a total silver weight of not more than 0.23 g/m² in the yellowing imaging later, as silver halide emulsions of the blue-sensitive layer, exhibited improved radiation resistance and enhanced sensitivity and was stable even when the exposure intensity or the developing condition was varied, as compared to comparative example. It was further proved that samples 403 and 404 using silver halide emulsions which satisfied the equations (VII) and (VII′), and occluding a group 8 metal complex and having a total silver weight of not more than 0.23 g/m² for the yellow image forming layer, resulted in improved radiation resistance without vitiating sensitivity, reciprocity law failure and process stability, compared to sample 402.

### Example 5

From green-sensitive silver halide emulsions H-1 and I-1, or red-sensitive silver halide emulsions J-1 and K-1, green-sensitive silver halide emulsions or red-sensitive silver halide emulsions meeting the preferred requirements were prepared similarly to the foregoing blue-sensitive silver halide emulsions, applied to the green-sensitive layer or the red-sensitive layer and evaluated similarly to Examples 2 to 4. Consequently, it was proved that superior results were obtained similarly to the results of the blue-sensitive layers, obtained in Example 2 to 4.

Further, silver halide color photographic material samples were prepared, in which silver halide emulsions relating to the invention were applied to the respective blue-sensitive, green-sensitive and red-sensitive layers and the total silver content was varied to the range of 0.45 to 0.55 g/m². As a result of evaluation thereof, it was proved that superior results were obtained at the silver content of not more than 0.51 g/m² and further superior results were achieved at the silver content of not more than 0.48 g/m².

While the invention has been described in detail and with reference to specific embodiments thereof, it will be apparent to one skilled in the art that various changes and modifications can be made therein without departing from the spirit and the scope thereof.

What is claimed is:

1. A silver halide color photographic material comprising on a reflective support an yellow image forming layer, a magenta image forming layer and a cyan image forming layer, each of which contains silver halide grains having a chloride content of not less than 90 mol %, wherein the photographic material satisfies at least one of the following equations (I), (II) and (III):
B(450)/[A′(450)−A(450)]≧60 (I)
B(550)/[A′(550)−A(550)]≧160 (II)
B(650)/[A′(650)−A(650)]≧260 (III)
wherein A(450), A(550) and A(650) represent fog densities of unexposed areas at wavelengths of 450 nm, 550 and 650 nm, respectively and B(450), B(550) and B(650) represent maximum densities at wavelengths of 450=m, 550 and 650 nm, respectively, when the photographic material is subjected to imagewise exposure and color processing; and A′(450), A′(550) and A′(650) represent densities of unexposed areas at wavelengths of 450 nm, 550 and 650 nm, respectively, when the photographic material is subjected to overall exposure to a radiation of 300 mR and then further subjected to imagewise exposure and color processing.

2. The photographic material of claim 1, wherein the photographic material satisfies at least one of the following equations (I′), (II′) and (III′):
B(450)/[A′(450)−A(450)]≧90 (I′)
B(550)/[A′(550)−A(550)]≧240 (II′)
B(650)/[A′(650)−A(650)]≧360 (III′).

3. The photographic material of claim 1, wherein the photographic material satisfies at least one of the following equations (IV), (V) and (VI):
DY(0.5)−DY(10⁶)≦0.2 (IV)
DM(0.5)−DM(10⁻⁶)≦0.2 (V)
DC(0.5)−DC(10⁻⁶)≦0.2 (VI)
wherein DY(0.5), DM(0.5) and DC(0.5) are yellow, magenta and cyan densities, respectively, when the photographic material is subjected to exposure at a time of 0.5 sec. and color processing, and DY(10⁻⁶), DM(10⁻⁶) and DC(10⁻⁶) are yellow, magenta and cyan densities, respectively, when the photographic material is subjected to exposure at a time of 10⁻⁶ sec. and color processing, provided that DY, DM and DC represent yellow, magenta and cyan densities, respectively, obtained at an exposure amount of 0.5LogE greater than an exposure amount giving a density of 0.7.

4. The photographic material of claim 1, wherein silver halide grains contained in at least one of the yellow, magenta and cyan image forming layers are chemically sensitized with at least two chalcogen compounds.

5. The photographic material of claim 1, wherein silver halide grains contained in at least one of the yellow, magenta and cyan image forming layers are spectrally sensitized with a sensitizing dye in an amount satisfying at least one of the following equations (VII), (VIII) and (IX):
VY>3.2×10⁻⁴/LY (VII)
VM>2.3×10⁻⁴/LM (VIII)
VC>0.6×10⁻⁴/LC (IX)
wherein VY, VM and VC represents an amount (mol/Ag mol) of the sensitizing dye contained in each of the yellow, magenta and cyan image forming layers, respectively; and LY, LM and LC represents an average grain size (μm) of silver halide grains contained in each of the yellow, magenta and cyan image forming layers.

6. The photographic material of claim 5, wherein silver halide grains contained in at least one of the yellow, magenta and cyan image forming layers are spectrally sensitized with a sensitizing dye in an amount satisfying at least one of the following equations (VII′), (VIII′) and (IX′):
VY>3.2×10⁻⁴/LY (VII′)
VM>2.3×10⁻⁴/LM (VIII′)
VC>0.6×10⁻⁴/LC (IX′)
wherein VY, VM and VC, and LY, LM and LC are each the same as defined in the equations (VII), (VIII) and (IX) of claim 5.

7. The photographic material of claim 1, wherein silver halide grains contained in at least one of the yellow, magenta and cyan image forming layers contain at least one selected from the group consisting of a group 8 metal complex containing at least one aqua ligand and at least one organic ligand in an amount of from 1×10⁻⁸ to 1×10⁻⁴ mol/Ag mol).

8. The photographic material of claim 1, wherein the total weight of silver of the yellow, magenta and cyan image forming layers is not more than 0.51 g/m².

9. The photographic material of claim 1, wherein the total weight of silver on the yellow, magenta and cyan image forming layers is not more than 0.48 g/m².

10. The photographic material of claim 1, wherein the total weight of silver of the yellow image forming layer is not more than 0.23 g/m².

11. An image forming method comprising the steps of:
subjecting a silver halide color photographic material as claimed in claim 1 to scanning exposure and
subjecting the exposed photographic material within 0.1 to 30 sec. after the scanning exposure to color development for 5 to 30 sec.
